(19) United States
(12) Patent Application Publication
(10) Pub. No.: US 2014/0345793 A1
(43) Pub. Date: Nov. 27, 2014

(54) Presses for Forming Composite Articles

(71) Applicant: Jamin Micarelli, Woodinville, WA (US)

(72) Inventor: Jamin Micarelli, Woodinville, WA (US)

(21) Appl. No.: 14/270,306

(22) Filed: May 5, 2014

Related U.S. Application Data
(63) Continuation-in-part of application No. 13/758,762, filed on Feb. 4, 2013, now Pat. No. 8,714,961.
Application No. 13/758,762 is a division of application No. 13/049,765, filed on Mar. 16, 2011, now Pat. No. 8,366,984.
Application No. 13/049,765 is a division of application No. 12/401,582, filed on Mar. 10, 2009, now Pat. No. 7,910,039.
Application No. 12/401,582 is a continuation-in-part of application No. 13/113,070, filed on May 22, 2011, now abandoned.
Application No. 13/113,070 is a continuation-in-part of application No. 13/412,363, filed on Mar. 5, 2012, now abandoned.
Application No. 13/412,363 is a continuation-in-part of application No. 13/488,380, filed on Jun. 4, 2012, now abandoned.
(60) Provisional application No. 61/068,964, filed on Mar. 10, 2008.

(51) Int. Cl. B32B 37/10; B30B 5/02

(52) U.S. Cl. CPC B32B 37/1018; B30B 5/02
USPC 156/229; 100/211

(57) ABSTRACT

A press with a pressure chamber and at least one elastomeric pressure vessel. The pressure vessel is filled with a substantially incompressible fluid that is in fluid communication with a pressurized source of the fluid. Two closable cylindrical press halves and a plurality of cylindrical bands that slidably engage able over the ends of the press halves. Two closable press halves and a plurality of spaced-apart and hinged reinforcement arm pairs. Each arm pair is spaced from, yet connected to, each adjacent arm pair so that all arm pairs may be opened and closed together.

An elastomeric press bladder for a hot isostatic press. The bladder is sized to fit one end of the pressure chamber and has a circumferential embedded metal ring. The circumference of the bladder has molded lip edges having at least one cross-section complimentary to at least one shaped hollow in respective bladder/press mating parts. The bladder has slits spaced at concentric intervals from a bladder circumference on both a bladder top and a bladder bottom.

A method of making a composite article with preform deep draw, active vacuum and active stretch.

### CROSS REFERENCE TO RELATED APPLICATIONS

This application is a continuation-in-part of U.S. patent application Ser. No. 13/758,762 filed Feb. 4, 2013 which is a division of U.S. patent application Ser. No. 13/049,765 filed Mar. 16, 2011 now issued on Feb. 5, 2013 as U.S. Pat. No. 8,366,984 which was a division of U.S. patent application Ser. No. 12/401,582 filed Mar. 10, 2009, now issued as U.S. Pat. No. 7,910,039 on Mar. 22, 2011 and which claimed priority to U.S. Provisional Application 61/068,964 filed Mar. 10, 2008, all of which are incorporated herein by this reference as if fully set forth herein.

### TECHNICAL FIELD

The invention relates to the field of presses and press molding; particularly, it relates to methods and apparatus for forming high strength composite articles; more particularly, it relates to a hot isostatic press (HIP) of the type that has come to be known in the industry as a Boroclave.

### BACKGROUND OF THE INVENTION

In a conventional hydraulic press there is a steel piston chamber that contains oil and as oil is pumped into the piston chamber, the piston is pushed out of the piston chamber into pressurized contact with a work piece. In an alternate, or hydro-forming press, high-pressure water is forced into a closed chamber against a metal sheet or tube and, as the pressure builds in the chamber, the sheet is pressed and stretched into a cavity behind it.

Another press positions a work piece between a conventional movable forming die and an expandable bladder optionally filled with fluid under pressure. Still another press uses an enclosed inflatable container in communication with hydraulic fluid reservoirs to provide the pressure for the ram in the hydraulic press so the hydraulic fluid is never in direct contact with any of the structural mechanisms of the press.

In conventional press designs, the chamber is closed with a rubber gasket or a low pressure seal, or as is the case with a hot isostatic press (HIP) a simple screw type plug lock. In a conventional HIP press, the pressure transfer medium is a hot gas such as nitrogen or argon, or water, or oil or a rubber crumb, and heating and cooling is achieved by thermal transfer to the work piece through the gas or other transfer medium, or a by a heated mold.

In forming advanced composite articles under high pressures and temperatures, it is recognized that certain silicone compounds are useful as uniform pressure transmitting media, and U.S. Pat. No. 4,770,835 to Kromrey is incorporated herein by reference as if fully set forth in order to provide further background about such compounds.

Conventional high strength, low weight structural composites are made from materials such as fiberglass or graphite. The composite article is typically made of multiple layers of so-called pre-pregs (combination resin and fiber materials) which have been laid up over a mold or die and thereafter cured under selected temperature and pressure conditions. Curing of the pre-preg layup is conventionally accomplished in an autoclave and requires the use of a vacuum bag or other type of barrier to prevent the pressurized fluid or gas from penetrating the layers and ruining the composite article which is being fabricated. But autoclaves are expensive and limited in pressure range and vacuum bags have a tendency to leak, resulting in a comparatively high reject rate.

An autoclave is one kind of Hot Isostatic Press (HIP) which in general applies both heat and pressure to the workpiece placed inside of it. Typically, there are two classes of autoclave. Those pressurized with steam can process workpieces that are able to withstand exposure to water, while the other class circulates heated gas to provide greater flexibility and control of the heating atmosphere, and for pieces that cannot withstand exposure to water.

Processing by autoclave is far more costly than oven heating and is therefore generally used only when isostatic pressure must be applied to a workpiece of comparatively complex shape. For smaller flat parts, conventional heated presses offer much shorter cycle times. In other applications, the pressure is not required by the process but is integral with the use of steam, since steam temperature is directly related to steam pressure. Rubber vulcanizing exemplifies this category of autoclaving.

For exceptional requirements, such as the curing of ablative composite rocket engine nozzles and missile nosecones, a hydroclave can be used, but this entails extremely high equipment costs and elevated risks in operation. The hydroclave is pressurized with water (rather than steam); the pressure keeps the water in liquid phase despite the high temperature. Since the boiling point of water rises with pressure, the hydroclave can attain high temperatures without generating steam.

While simple in principle, this brings complications. Substantial pumping capacity is needed, since even the slight compressibility of water means that the pressurization stores non-trivial energy. Seals that work reliably against air or another gas fail to work well with extremely hot water. Leaks behave differently in hydroclaves, as the leaking water flashes into steam, and this continues for as long as water remains in the vessel. For these and other reasons, very few manufacturers will consider making hydroclaves, and the prices of such machines reflect this.

One proposed solution has been to utilize so-called trapped rubber molding systems to cure such components. This is generally a closed container or mold within which is placed a cured elastomer such as a silicone rubber that has a high coefficient of thermal expansion. Heating the part in the mold in the container causes the surrounding elastomer to expand and, when the apparatus is properly configured, the elastomer then applies a uniform isostatic pressure to the pre-preg layup in the mold or on the die.

Another proposed solution is to encapsulate or pre-cast a work piece inside a crushable ceramic, and then apply pressure to the ceramic to simultaneously crush it and expose the work piece to consolidation pressure.

What does not yet appear is any means or method of providing a primary pressure source to a pressure transfer medium in a press that does not involve some kind of conventional ram (hydraulic, mechanical or otherwise) or thermal expansion aspect. What is needed is a press filled with a substantially incompressible medium such as silicone, where the medium at least partially encloses a resilient or elastomeric vessel filled or fillable with fluid such as oil or water that is in fluid communication with a source of pressurized fluid, such that, as the vessel is pressurized inside or against the transfer medium, the pressure expands throughout the medium to provide a substantially uniform pressure to a work piece placed against a mold or tool disposed within the press.

What is also needed is a rapid cycling, high pressure press, that can be rapidly and readily opened to remove and replace a consolidated composite article with a new pre-preg layup, and then rapidly and effectively closed and sealed again for the next part cycle. What is needed is a high pressure low cost system capable of high production volumes and rapid part cycle times

### DISCLOSURE OF THE INVENTION

Basic Boroclave

A press is disclosed herein that is filled with a pressure transfer medium such as a substantially incompressible medium such as silicone, where the medium at least partially encloses a resilient or elastomeric vessel filled or fillable with fluid such as oil or water that is in fluid communication with a pressurized source of the same fluid. The press generally has a pressure chamber containing a pressure transfer medium and a high pressure resilient or elastomeric bladder, gasket or vessel.

Our U.S. Pat. No. 7,862,323 (incorporated herein by reference) discloses a new kind of HIP press or pressure chamber where both heat and isostatic pressure can be applied to layered composites over comparatively complex shapes. We call such a press or pressure chamber a Boroclave. The Boroclave does not use water as a pressuring or pressure transfer medium. Some kinds of Boroclave can be either oil or silicon filled, or a combination of both, with suitable separation materials. The Boroclave press disclosed in the '323 patent is filled with a substantially incompressible medium such as silicone, and the medium at least partially encloses a resilient or elastomeric vessel filled or fillable with fluid such as oil or water and in fluid communication with a source of pressurized fluid, such that, as the vessel is pressurized inside the transfer medium, the pressure expands throughout the medium to provide a substantially uniform pressure to the work piece against the mold. The Boroclave advantageously employs a barrier or bladder to separate the pressure transfer medium itself from the layers of the composite article which is being fabricated.

Also disclosed is a short cycle heating and cooling apparatus and method for the mold and work piece, in a pressure chamber or vessel that is adapted to be readily and rapidly closed and locked to facilitate rapid part cycling into and out of the press. Suitable silicones, in addition to those disclosed by Kromrey, include platinum cure thermal setting silicones.

Active pressure and locking are types of lids or press closures that are advantageous for rapidly opening and closing a press and rapid part replacement in the press. Such closures may be lids or may be other closure systems. For instance in one active pressure closure, a lid closure is held closed under active hydraulic pressure; in another active pressure closure system, a lid of a press enclosure is first closed and locked on the enclosure, hydraulically or otherwise, and then an open pressure chamber inside the enclosure is hydraulically raised or lifted to seal a lip or sealing surface of the open chamber against a mating sealing surface of the enclosure lid, and then actively hydraulically held in that mating and sealed relationship until the composite article is completed, whereupon the chamber pressure is reduced, the chamber is lowered releasing the seal, and the enclosure door is opened to remove and replace the article.

In one locking chamber design the lid is closed via cams, levers and locking pins (optionally hydraulically assisted or activated). In another locking chamber design, the lid is closed with locking threads, such as artillery breach screw threads. Breech screws have interrupted threads which allow the screw to be locked or unlocked by a partial turn of the screw. Their strength depends on their length, diameter, and the percentage of the surface carrying screw threads, so the greater the percentage bearing surface the shorter the breech screw needs to be and the easier it is to open. Some breech screws have interrupted threads. Locking lids may advantageously be gates or doors, sliding or hinged, or artillery style breach threading.

In a disclosed press, instead of a steel hydraulic piston chamber with a movable steel piston, there is pressure chamber (that may optionally be lined with a rubber bladder). Inside this pressure chamber there is a resilient or elastomeric pressure vessel suspended at least partially in or against a substantially incompressible pressure transfer medium, such as solid silicone, or particulate silicone (beads), or a combination of the two. Sometimes this vessel is referred to herein as an expandable bladder. The vessel is advantageously made from a grade of rubber that is highly elastic, durable over 1000s of expansion cycles and impervious to the fluid selected for filling the vessel at operating pressures and temperatures. Alternate vessel or bladder materials and configurations as discussed further herein as well.

The expandable bladder or vessel is in fluid communication with a source of high pressure fluid, such as oil or water. This elastomeric pressure vessel is adapted to expand in two ways, and at two stages. In a first stage at relatively low pressures, as the transfer medium itself is compressed and coalesced, and as any negative mold or work space is taken up and filled with the flowable and compressed transfer medium, the vessel or bladder itself literally expands to fill the available space, and concurrently, the vessel receives more fluid to effect this expansion, enabled in this expansion by the elastomeric nature of the vessel. In a second stage at operating consolidation pressures (advantageously about 3000 to 10000 psi, or about 21 to 69 MPa), the vessel or bladder no longer literally expands to any significant extant (generally only such as necessary to accommodate and account for the slight further compression of the pressure transfer medium at operational pressures), but its elastomeric nature causes any pressure increase inside the vessel that is generated by increased pressure from the source of high pressure fluid (such as a hydraulic pump) to be transmitted across the elastomeric barrier and into the transfer medium, in a way that would not be possible if the vessel were rigid.

“Suspended in the transfer medium” means that the pressure vessel or bladder is generally and advantageously enclosed by the transfer medium material. This suspension or enclosure may optionally and selectably be set up to vary from partial enclosure to complete enclosure. It is generally advantageous to have the pressure vessel inside, or at least partially inside, the transfer medium matrix, and not outside.

“Substantially incompressible” means that at operating consolidation pressures, there is less than about 2% further compression of the transfer medium after initial voids and/or other spaces in the flowable transfer medium material are coalesced into what is sometimes referred to as a continuous void-free body.

As the suspended and expandable bladder is filled with high pressure fluid, it in turn pressurizes the transfer medium which, once all the unoccupied space (sometimes referred to herein as negative space) in the chamber is compressed, in turn uniformly transfers pressure to the formable part or work piece that has been positioned between the mold in the chamber and the transfer medium for consolidation. “Uniform transfer” means that the pressure exerted by the pressurized fluid in the elastomeric pressure vessel is substantially uniformly applied in a hydraulic-like manner throughout the transfer medium, and to all surfaces with which the transfer medium is in contact, including the chamber walls and the work piece.

Optionally, the mold and work piece may be outside the silicone transfer medium matrix, and still in a pressure-mating relationship to the matrix, such that uniform pressure is applied by the matrix to every point on the work piece against the mold. Alternatively, the mold and work piece may be enclosed within the matrix, where uniform pressure is applied to all sides of the work piece against the mold and also the faces of the mold that are away from the work piece. Advantageously, in this instance, the mold and work piece may be enclosed within a bag that is ventable to release any trapped air, or otherwise separated from the pressure transfer medium by a barrier. As the preferred pressure transfer medium is generally not reactive with the composite materials, the barrier or bag may be either permeable or non-permeable.

The pressure transfer medium (or transfer material) can be made from a number of substantially incompressible elastomers or elastomeric substances. See Kromrey. One method disclosed is to fill the pressure chamber with high strength, high elongation silicone with the expandable oil bladder encased inside the block of silicone. Another method is to cast a relatively thick skinned, shaped bag (sometimes referred to as a ‘rubber piston’) about 0.5 inches to 2 inches (about 1.2 to 5 cm) thick, and fill it with particulate silicone solid (particles, beads, crumb-balls or spheres), that can either be uniform or vary in size, and to suspend the expandable bladder or vessel inside the particulate silicon inside the rubber piston. A surface lubricating agent may optionally be added to lubricate interaction of the beads with each other and with the inside of the rubber piston, or self-complying, coalescing particulates such as disclosed by Kromrey may be employed. Yet another method is to employ particulate silicone as above and omit the bag, and use a retaining barrier to retain the particulates inside the press when the press is open as the particulates would otherwise be subject to spilling out.

As the inner bladder (pressure vessel) expands, the silicone is quickly pushed into any and all available free spaces, and then as the pressure from the expanding suspended bladder increases, the silicone is evenly distributed throughout the pressure chamber, or the rubber piston within the pressure chamber, and the pressure from the expanding bladder is transferred through the beads to the rubber piston surfaces (or to the chamber walls and the retaining barrier surfaces) uniformly.

A combination of solid and particulate silicones may also be used as a pressure transfer medium. In particular, an elastomeric bag of particulate silicone is optionally disposed between a solid silicone matrix and the mold and workpiece. Or in a press aligned or alignable with gravity (such as an ‘upright’ press), such that opening its lid leaves particulates inside the press rather than spilling out, a layer of particulates without either a bag or retaining barrier may be disposed over and above the solid matrix of silicone. Optionally in this ‘upright’ or gravity-held arrangement, the entire pressure chamber can be filled with particulates without a bag or retaining barrier.

In some press embodiments the entire pressure chamber is the pressure vessel, which is filled with silicon, or silicon pumped under pressure. In this embodiments the resilient or elastomeric vessel or bag fills entire chamber, and is not in the ordinary sense enclosed or surrounded by anything but the steel walls of the chamber.

In one version of a disclosed press, pressure to a work piece is created by the substantially uniform transfer to the work piece on the mold of hydraulic or hydraulic-like energy, sometimes referred to herein as an indirect transfer. Inside a pressure chamber there is a mold/platen combination (that can advantageously be either a male or female mold, or a combination of the two, and wherein the platen may be optionally built-in to the mold) that optionally includes a hot/cold mold or platen substrate which is either fluid or electrically heated and then fluid cooled.

For opening and closing the press, a lid-based design is advantageous for the pressure chamber, rather than the conventional guided platen design. This generally lowers the overall size and weight of the press by a large margin. The lid closes and is preferably locked in place by locking rods or clamps, or by artillery breach screw, or the like, or held in place by optional active hydraulic closure. Another advantage of the lid based design is that the required overall movement or stroke of the press can be much lower than a conventional press that needs to clear both consolidation space and working room. This reduces the amount of steel needed to build the press and lowers the size requirement of the press dramatically.

The disclosed press desirably takes on the form of a sealable pressure chamber capable of maintaining extremely high levels of mechanical pressure. A top- or side-closing lid that is locked or held in place provides rapid access to the chamber. The hot and cold platen and the mold may be in the chamber, or disposed upon the lid. In the remaining space of the chamber, between the transfer medium and the mold, a space is also provided for the materials or work piece that are to be consolidated.

The mold may be milled or cast out of a metallic material such as aluminum or steel or it may be cast out of a plastic material such as urethanes, or urethanes filled with a filler substance such as aluminum beads to increase compression strength and thermal conductivity from the hot platen to the part surface.

In operation of the disclosed press, the pressure chamber is closed and sealed and liquid is pumped under selectable and predeterminable pressure into the elastomeric vessel that is suspended in the silicone transfer medium. The amount of pressure that can be used is limited only by the capacity of the pump in the high pressure source, and by the strength of the chamber itself. The bladder is desirably sized such that the volume to which it is capable of expanding is greater than the volume of any open or remaining space in the chamber before operating pressures are applied.

In disclosed press designs, the guides and alignment equipment usually necessary on a conventional high pressure press are not necessary. This is believed to be due to the self-leveling of the liquid transfer of pressure, thus also reducing cost and labor required to assemble the press.

The pressure chamber can be of any shape or size, and made of any material or set of materials that can contain the necessary pressure. Optionally, in the case of a purpose built press, the female platen and the outer chamber may be the same thing. A block of steel or aluminum can have the reverse form milled out of it and a lid mounted on it. The bladder is inserted and the negative space filed with silicone. In this case the press would be a block of material with a lid mounted on it, again, reducing the overall cost dramatically.

A lid for closing and sealing the pressure chamber or press housing is optionally hydraulic in operation. In a conventional hydraulic press, a piston rod moves up or down to allow “daylight” between the press platens so that a part can be removed or new materials put in place. In this disclosure, the one of the press platens, such as the top platen, is the lid of a box design that is able to lock and unlock to accommodate opening or closing. Rather than having a stroke of 15 inches as in a conventional press, a press can have a stroke as short as 3 inches and still accommodate the same materials and effectively press and consolidate them. In the conventional press, the extra 12 inches of piston stroke are only there to have the platen open far enough to allow the user access to the press platen surface or the mold held within it. The lid is optionally held in place by hydraulically actuated locking pins, or by locking cams.

A method of forming a composite article from a work piece at elevated temperatures and pressures is also disclosed. In the disclosed method, the work piece is in contact with a mold and is disposed within a pressure chamber, and a substantially incompressible medium is disposed in the chamber so that the medium is capable of transferring a substantially uniform, predetermined medium pressure to the surface of the work piece. Within the substantially incompressible medium a fluid-filled elastomeric vessel in fluid communication with a source of high pressure fluid is disposed so that the vessel is capable of causing a substantially uniform, predetermined pressure to the substantially incompressible medium as pressure is elevated inside the vessel. The vessel is then caused to produce a pressure in the range of 400 to 20000 psi and desirably in the range of 6000 to 10000 psi (about 2.8 to 138 MPa or about 42 to 69 MPa, respectively) to be applied to the substantially incompressible medium so that it in turn applies a substantially uniform predetermined medium pressure to the surface of the work piece. The mold and work piece are then exposed to temperatures well known to those skilled in the art that are appropriate to effect consolidation of the work piece materials and create the composite article, and then lowering the temperature to levels that are also well known as effective for setting particular compositions of composite article.

An alternate method rearranges and varies the steps above to disposing a substantially incompressible medium in the chamber so that the medium is capable of transferring a substantially uniform, predetermined medium pressure to the surface of the work piece and disposing within the substantially incompressible medium an oil-filled elastomeric vessel in fluid communication with a source of high pressure oil so that the vessel is capable of causing a substantially uniform, predetermined pressure to the substantially incompressible medium, and then disposing upon a lid to the pressure chamber the work piece in contact with a mold, and pressure sealing the lid to close the chamber.

A press system for forming a composite article from a work piece at elevated temperatures and pressures is also disclosed. The system has a pressure chamber filled with a substantially incompressible medium, and the medium at least partially encloses an elastomeric vessel that is filled with a substantially incompressible fluid such as oil or water and is in fluid communication with a source of pressurized fluid. The work piece is disposed within the pressure chamber, and the substantially incompressible medium is disposed in the chamber so that it is capable of transferring a substantially uniform, predetermined medium pressure to the surface of the work piece in the following steps. The vessel is filled and pressurized to produce a pressure in the range of 400 to 20000 psi (2.8 to 138 MPa) that is thus applied to the substantially incompressible medium so that the pressure transfer medium applies a substantially uniform predetermined medium pressure to the surface of the work piece; the mold and work piece are exposed to temperatures appropriate to cause consolidation of the work piece layers, as is well known in the art, and depending on the number and composition of the layers, in a well known fashion; and reducing the mold and work piece temperature to set the composite article.

A alternate press has a pressure chamber filled with a substantially incompressible medium. The medium is pressurizable by at least one elastomeric pressure vessel formed in part on one end of the medium in the pressure chamber as a pressure bladder or plug. The other part of the pressure vessel is the end of the pressure chamber with a valved passageway that is in fluid communication with a pressurized source of pressure fluid. The bladder may be on the openable end of the pressure chamber and near to, or in contact with, the work piece, or it may alternatively be disposed across an end of the pressure chamber opposite or away from the workpiece.

Heating and Cooling

Also disclosed is a rapidly heating and cooling dual-purpose platen. The dual design includes a hot platen member (defined as a platen that has a heating system integrated, either fluid or electrical) and a cold platen member. The two platen members are assembled together with the cold platen member in contacting and thermal energy transferring relationship to the mold and work piece and to the hot platen member. The cold platen can be of varying shapes and sizes, and is generally a thinner platen with cooling channels or conduits in it that can be filled with either liquids or gases. In operation, the hot platen is advantageously maintained at consolidation press temperature, and only the cool plate is cooled as needed to cool and set the part after consolidation. The cool plate is relatively thin (for example, a hot plate 3 inches thick, with the cool plate only 1 inch thick) and made of a thermally conductive material, to aid in quickly cooling the platen and the part. When the cooling fluid is stopped, the hot platen member immediately begins heating the cool platen again. Thus during any heating cycle, the heaters only have to heat the top 1 inch or ¼ of the material of the combined platens. Thus the heating time is about ¼ or less of the time it would conventionally take to heat a full size (example 4 inch) platen, saving both cycle time and energy.

One heating/cooling platen combination is optionally in the shape of a part mold. The heating and cooling platen members can be in various geometric configurations, such as the heating plate in an inner circle and the cooling plate in an outer circle.

Liquid Media

A particular press has a pressure chamber filled with a liquid medium, the medium enclosing at least one tool in a bag that is desirably a vacuum bag. The liquid medium is cornstarch, oil, water, or silicone BBs or the like flowable material.

The disclosed liquid media technology can be applied to a Boroclave, but may also be applied to any locking pressure vessel or chamber. A particular press has a pressure chamber filled with a liquid medium, the medium enclosing at least one tool in a bag that is desirably a vacuum bag. The liquid medium is cornstarch, oil, water, or silicone BBs or the like flowable material.

Transferred energy from a standard boroclave bladder design/plug design is used to pressurize a liquid, or other flow able media, such as cornstarch, oil, water, silicone B-Bs or silicone marbles, or the like.

The composite part is placed on a rigid tool just like it would be in an autoclave tool. Example would be a ⅜″ carbon fiber epoxy tool (mold) formed in the shape of the desired part. Then the materials to be formed are placed on the composite or metal tool and a vacuum bag is placed over the composite laid-up part and tool. The bag can be adhered to the tool or around both the tool and the part. The vacuum bagged tool and part is then placed into the “liquid” media and the lid is closed on the chamber. Then the bladder/plug that is at the bottom of the chamber is inflated via pressurized oil and as it expands the liquid around the composite is pressurized and the pressure is slowly increased until the part is under the desired isostatic pressure.

The advantage of this is that tooling costs are believed to be lower than any other way to form advanced high pressure composites. And the adaptability of the disclosed system allows for low wear on the machine, as it also prevents wear on the bladder or plug. If any material does leak out of the chamber, it does not rupture the bladder or plug; the worst that happens is some leakage of disposable medium.

The tool may be heated or cooled and the media may be heated or cooled. The media can be any material that behaves as a liquid under pressure and is capable of transferring isostatic pressure.

Rippled Guide Deep Draw

One particular deep draw mold includes a first rippled guide that is peripheral to the opening of a female part of the mold. There is also advantageously a second rippled guide peripheral to the shoulder of a male part of the mold, and the first and second rippled guides have a loosely mating fit with each other. That is to say, they are of complementary fitting shapes so that material deep drawn through the guides is shaped (pleated) as it drawn.

Current deep draw methods for ballistic material rely on using multiple pieces of material specially shaped so that the final drawn product will have a uniform thickness. These methods are believed to create weaknesses in the final drawn end product because using various shapes for the material to be drawn is believed to be inherently weaker than using full sheets. Other methods of deep drawing composite material are believed to also stretch or harm the material such that it loses at least some of its ballistic properties.

New method and apparatus for deep drawing composite materials are disclosed that leave drawn sheets of ballistic material with no cuts, thus transforming flat sheet composite material into three-dimensional shapes such as helmets, face masks, or any other desired shape.

In conjunction with otherwise conventional match die press apparatus and processes for otherwise conventionally drawing composite sheet materials into a female mold shape, new matching rippled guide molds are used on the periphery of the female draw mold to guide the materials through as they are pushed through into the female draw mold shape by the action of the male part of the match die, or other kind of draw mold, press.

These “ripples” encourage the composite material to fold at the lines created by the ripples, and the action of the press pushes the thus folded material into the female mold. The female mold is designed to accept additional material at the locations of the ripples, which provides additional space for the folded material as compared to the straight material, while at the same time using the pressure of the press to stretch and limit the thickness of the folds to present a generally more uniform thickness.

The matching rippled guide molds are also male and female, and advantageously generally ring shaped, to fit around the circumference or periphery of the respective female and male draw mold parts. These peripheral rippled molds are generally conically disposed, to reduce friction on the material and avoid damage to the ballistic sheets as they are pressed through into the female draw mold.

By intentionally placing folds in the composite material as it is drawn and pressed, where the additional space in the female mold is needed to allow for the extra fold thicknesses can be accommodate. Part of the process includes providing active pressure on the composite material as it is drawn and folded, so that where the folds occur, they are pushed to the limit of the composite material, reducing the size of the folds. Since too much pressure on the folds can damage the composite material, balancing of draw forces maintains the ballistic characteristic of the material.

In addition to the strength of the material being maintained through use of whole sheets, the process also creates a “pleating effect” in the pressed composite material. This pleating effect is believed to generate additional time and space for capturing projectiles before they can break through the composite. Additionally, the pleating is believed to actively spread the load created by the impact over a wider area for minimal backface, and provides much lower subjective impact to the protected person or vehicle because the surface area of the impact is spread over a wider effective area.

Offset Preform Deep Draw

Another particular deep draw press/mold system is a preform drawing process that has an offset draw mold that includes matched female/male mold parts that are offset from one another in their respective closed positions (that is, they do not close completely on the work piece) such that a work piece of composite materials placed inside the mold is subjected to shaping with only minimal to no pressure, and such minimal pressure is insufficient to create a consolidated composite material mass. This press system is designed for deep drawing only, and not for consolidation of composite parts. Consolidation in an appropriate HIP press is an optional second stage after this deep draw stage.

Current deep draw methods for ballistic material rely on using multiple pieces of material specially shaped so that the final drawn product will have a uniform thickness. These methods are believed to create weaknesses in the final drawn end product because using various shapes for the material to be drawn is believed to be inherently weaker than using full sheets. Other methods of deep drawing composite material are believed also to stretch or harm the material such that it loses at least some of its ballistic properties.

In one known process, a set of matched metal dies are closed under high pressure and heat to consolidate the composite material especially unidirectional polyethylene spun fibers in a variety of thermoplastic resin systems into a ballistic helmet or part. This is a single stage process where the material is drawn like sheet metal into a set of molds under pressure.

The disclosed process is unique from current deep draw methods for ballistic composite materials. New processes for deep drawing composite materials are disclosed that leave drawn sheets of material, for instance ballistic material, with no cuts, thus transforming flat sheet composite material into three-dimensional shapes such as helmets, face masks, or any other desired shape.

In conjunction with otherwise conventional match die press apparatus and processes for otherwise conventionally drawing composite sheet materials into a female mold shape, the following is disclosed.

Ballistic materials are stacked, such as in example below, and then preheated as further described below, and then preformed inside the desired female/male mold pairing into a non-consolidated material mass. It is believed that, in the absence of significant pressure inside the mold, the material stack is subjected to only minimal pressures, and therefore there is little to no material distortion, such as stretching and/or tearing. Then as a step separate in point of time, the preformed ballistic material is placed again into the desired female/male mold and subjected to isostatic pressure and heat as further described below to consolidate the material into a post form ballistic product.

In an example process, the material is drawn into an offset pre-form mold where little or no pressure is applied. It is possible for the material to stretch as it is drawn but it is at no time placed under sufficient pressure to fully consolidate it. This non consolidated part is than removed and placed in a hydrostatic pressure forming vessel and heated to the appropriate temperature to ensure resin wet out. High pressure is than applied to the part while under vacuum or positive vacuum where gasses can still flow out of the high pressure environment to the lower pressure existing outside the pressure vessel. The composite is than fully consolidated in the high pressure isostatic environment into a part with full ballistic capabilities.

This method protects the delicate fiber from any damage that would normally occur during match die operations as well as providing perfect consolidation on every surface of the complex shaped part. This is believed to be impossible in a conventional match die deep draw.

Desirably, match metal molds having an intentional offset or set off are used in the disclosed pre-forming operation. Such offset molds are specially formed or tapered to accommodate shaping of the composite material without consolidating it. In a disclosed offset mold, it will not be possible to achieve any kind of consolidation pressure, as the mold parts are offset by the expected thickness of the pre-form material stack, such that the stack can be formed but not pressed. Alternatively, a non offset mold set may be used, but not run up to full consolidation pressures.

Bladder Technology

Bladder Gasket with Embedded Ring

A hot isostatic press (HIP) has a press bladder that has a circumferential embedded metal ring. This bladder also has alternate edge configurations with one or two edge lips or end regions of the bladder that are complementary in shape to mating press closure parts.

In conventional press designs, the chamber is closed with some kind of rubber gasket or a low pressure seal, or as is the case with a hot isostatic press (HIP) a simple screw type plug lock. In a Boroclave, as disclosed herein, the chamber is generally closed with some kind of elastomeric rubber or silicone bladder gasket, which serves both to seal the chamber and to transfer pressure from the disclosed pressure transfer medium to the work piece and mold.

Conventional high strength, low weight structural composites are made from materials such as fiberglass or graphite. The composite article is typically made of multiple layers of so-called pre-pregs (combination resin and fiber materials) which have been laid up over a mold or die and thereafter cured under selected temperature and pressure conditions. In a Boroclave, curing of the pre-preg layup requires the use of a barrier or bladder to separate the pressure transfer medium itself from the layers of the composite article which is being fabricated.

As the transfer medium is pressurized, pressure expands throughout the medium to provide a substantially uniform pressure against the bladder gasket to the work piece against the mold. In some applications, elastomeric stretching of the bladder gasket inside the press under working pressures can be extreme, and in some cases, great enough to tear the bladder or even pull the gasket right out of its sealing space, which in turn causes failure of the press.

Two such improved rubber bladder gaskets that can withstand repeated extreme stretching under working pressures and which is designed with an embedded circumferential ring so that they cannot be torn out of their sealing spaces are disclosed. Also disclosed are press half mating surface designs in Boroclave sealing areas that correspond respectively with, and are designed to retain, each respective disclosed bladder gasket.

### Dual Form Deep Draw Bladder

A particular hot isostatic press (HIP) has a press bladder that has at least two layers, a urethane layer and a silicon layer. The silicon layer is for facing a pressure fluid chamber part of the press and the urethane layer is for facing a workpiece disposed within the press. The two layers are advantageously co-molded, but they are separate or separable, and they are installed together to seal the pressure fluid chamber. Alternatively the two layers are bonded together.

In one kind of conventional deep draw press a work piece is positioned between a conventional movable deep draw forming die and an expandable bladder generally filled with fluid under pressure. This is sometimes referred to as a hydrostatic deep draw. The forming die is operated by a conventional ram cylinder and the bladder is some kind of a isostatic pressure vessel, all in a lidded, lockable pressure vessel.

In general, the vessel locks closed trapping a work piece, typically sheet metal, then high pressure is applied to the bladder from one side pinning the material to a flat platen on the other side. Once the material is under pressure the hydraulic ram with a mold piece mounted on it is forced up through the bottom of the platen. Under full pressure the ram displaces liquid in the pressure chamber and in the process draws the flat material into a deep and complex shape. Deep draw in this kind of application generally refers to any draw where the depth of the draw is greater than half the diameter of the finished piece (also sometimes where the depth is greater than the diameter of the piece). Then the pressure in the bladder or isostatic vessel is lowered, the ram is retracted and the vessel is unlocked and opened to remove a finished formed part.

Examples of this kind of press may be found in Pryer Technology Group's Triform Hydroform Presses http://www.pryertechgroup.com/about_hydroform.html.

Conventional high strength, low weight structural ballistic composites are made from materials such as fiberglass or graphite. The composite article is typically made of multiple layers of such material, sometimes combining one or more types of material. Conventionally such stacks of composite fabric are laid up over a mold or die and thereafter cured under selected temperature and pressure conditions.

In this deep draw press, where a workpiece is positioned and held between the movable deep draw forming die and some kind of isostatic pressure vessel generally filled with fluid under pressure, the vessel is sealed with a flexible and expandable bladder or plug, and this bladder is in working contact with the workpiece. As such it is subject to considerable wearing and tearing forces over the course of many press cycles. Conventionally, the bladder is made of a urethane compound because urethane is known for superior wear properties.

In the Boroclave press configuration disclosed however, the bladder is also subject to severe heat strains. A dual form bladder that is made of both urethane and silicon compounds addresses these concerns. It can withstand repeated extreme stretching under working pressures and is designed so that it cannot be torn out of its sealing space. Desirably there are two layers to the bladder or plug, a workpiece facing layer made of urethane, and an inner layer that is exposed to the heated fluid of the pressure chamber and that is made of silicon. The two layers may be co-molded, but separate or separable, and installed together to seal the pressure fluid chamber so they act as a single bladder or plug. Alternatively, the two layers may be bonded together, either as part of the molding process in which they are formed, or after they are separately molded and formed, and before they are installed as a plug unit to seal the pressure fluid chamber.

### Intelligent Slitting

A resilient press bladder has slits spaced at concentric intervals from the bladder circumference on both a bladder top and a bladder bottom, the slits in the top offset from the slits in the bottom, such that as the bladder is stretched with deformational forces, the slits are widened, and as deformation forces are abated or relieved, the bladder and its slitting resume their pre-deformation configurations.

When a press bladder is expanded, either due to molding pressures, or during a deep draw process, there is considerable stress on the holes in the periphery of the bladder that are used for passing through the locking bolts for holding the bladder in place. Under this stress the holes expand and at least some of the pressure medium, whether oil or silicone, is able to leak out from deformed through-holes around the bolts at the attachment points.

A system and method for ameliorating or relieving stress at bladder through holes is disclosed. The disclosed system manages elongation and stress dispersal in a bladder used during a deep draw high pressure process. A resilient bladder material is slitted at concentric or peripheral intervals from the bladder edge(s), with the slits in a notionally ‘above the bladder’ side advantageously offset from the slits in a notionally ‘below the bladder’ side, such that as the bladder is stretched with deformational forces, the slits are widened. As deformation forces are abated or relieved, the bladder and its slitting reassume their pre-deformation configurations.

Active Sealing, Floating Gasket

A seal or gasket for a high pressure vessel and lid has a relatively rigid member and a relatively resilient member with a space between them. The members are joined along one edge, and the relatively rigid member has a surface for press fit relationship to a selected respective one of the vessel or the lid. The relatively resilient member is adapted to fit the respective other one of the vessel or the lid. The space between the two members is desirably filled with a substantially incompressible, elastomeric medium such as silicon or silicon based material.

A floating gasket seal has reciprocally matching plug and socket members. The socket member is in fluid communication with a region of atmospheric to below atmospheric pressure (relative vacuum). The plug member is displaced from the socket member at least partially for fluid flow around the plug, until a pressure on the plug side of the seal drives the plug into the socket. The plug has a cross-sectional wedge shape when it is used as a circumferential gasket, and a frusto-cone shape when use with a vacuum bag in which the seal is disposed for sealing the bag.

Manufacturing with advanced high density composites requires pressure vessels capable of delivering very high pressures. In addition, composite lay-ups in the pre-press stage entrain a significant amount of trapped air, which, if it is not released prior to applying the high pressure, results in flawed composites, often brittle or likely to fail well below expected performance parameters.

In a conventional low pressure autoclave, heat and pressure are applied to a composite part that is wrapped in a vacuum bag, which is in turn connected to a vacuum line. A vacuum is drawn down on the part to evacuate all trapped air from the part, and the vacuum is maintained during application of the pressure, so that whatever air the initial vacuum could not entice out, is pressed out under the pressure of forming the part. This conventional method works, in part, because of the relatively low order of pressure (typically <400 psi, commonly about 200 psi) being applied internally, not only to the bagged part, but also to the vacuum lines themselves.

Such a vacuum system will not work in a chamber that delivers much greater pressure, and certainly not in a chamber where pressures may reach 10,000 psi; the vacuum lines themselves would be crushed.

Of course another well-known alternative for a press to release trapped air is a so-called flat press, with no restrictions on air escaping from the sides of the part.

An apparatus and process that can be used in a very high pressure composite press and that will allow all entrained air to escape or be pressed out of the part before it is subjected to the full working pressure of the press is disclosed.

In a Boroclave press it is advantageous to employ compressible gaskets to seal in silicone under high pressure. These gaskets may be conventional, or they are desirably a novel silicone filled, wedging arrangement as disclosed herein. In general, disclosed wedging gaskets have one (typically an outer, but could optionally be inner) relatively rigid member with a surface that is in mating press fit relationship to the vessel or lid to be sealed, and another, slightly angled, inner (or outer) slightly resilient member appropriately shaped to mate with the respective other part of the vessel or lid to be sealed, generally in something less than an interference fit. The requisite slight resilience of the angled member is achieved with selection and dimensioning of the material of the angled member, as will be appreciated by those skilled in the art, so that the angled member can be deformed and then spring back to its original dimension and configuration.

A space or void between the gasket outer member and the angled inner member is advantageously filled with silicone or other substantially incompressible but elastomeric medium. In operation then, as the lid is closed or the pressure chamber is otherwise closed, the angled inner member of the gasket is aligned and preliminarily mated with its respective sealing surface. This preliminary mating is not a fully sealed relationship however, and any gases under pressure in the vessel are vented or ventable through this gasket as the pressure in the vessel increases. Then after initial compressing pressure is applied inside the chamber and trapped or entrained gases such as air are vented out through the gasket's not yet perfect seal, the transfer medium is pressed against the silicone inside the gasket, and the silicone inside the gasket in turn slightly deforms the angled member into an increasingly perfect interference fit with the respective mating surface.

Once this phase of increasing pressure has ‘set’ the gasket, the pressure is further increased to operational range, with each increment of pressure serving to further pressurize and hold the angled member against its sealing surface via the pressure transfer laterally through the silicone in the gasket to the angled member. Such gaskets desirably have a corner-free, or rounded, or U-shaped cross-section at the junction of the outer (or inner) member and the angled member. When the pressure in the chamber is reduced, and the corresponding pressure holding the angled member against its respective sealing or mating surface is released, the angled member springs back to its un-pressured configuration and dimension (permitted by the silicone's resilience), and the gasket ceases to be an interference fit, and the chamber lid or door is thus readily opened.

An alternative to the sealing process and mechanism disclosed above employs a kind of floating gasket plug and mating socket mechanism as an escape valve for trapped gasses; the socket is generally circumferential and shaped and sized to suit the shape of the plug. Where the floating gasket is in the form of a single point escape valve, such as for use in vacuum bagging as disclosed herein, the plug is desirably in the form of a frusto-cone (truncated cone).

One problem with the development of such an escape valve for high pressure presses is that to the extent such a valve represents an opening to the atmosphere or outside of the pump, the pressure medium (such as silicon) can be pressed through the valve, as well as the intended escaping air, especially at high operating pressures.

One way to avoid having pressure medium pressed out, is to stage the increases in pressure, such that there is first a pressure sufficient to press out trapped air, but not high enough pressure to cause pressure medium to enter the relatively narrow confines of the valve. Then when the air or other gas is gone, increasing the pressure against the wedge to seal it into its socket, before the pressure medium can be pressed out in any significant amount. Desirably, at least one surface of the wedge and or of the mating surface in the socket is either knurled lightly, or simply mechanically roughed slightly. These rough edges impose no significant barrier to the release of air through the valve, and as pressure is increased, the knurling or roughness is crushed into an effective sealing surface so pressure medium cannot escape.

One advantageous way to employ this wedge and socket valve mechanism is in conjunction with a modification of an otherwise conventional vacuum bag. The modified bag has a wedge-shaped valve piece incorporated into it, such that the wedge can be plugged into a socket surface in an outer wall or floor of the press, or alternatively built into the mold piece itself. Each composite part is bagged and plugged into an available socket, and then the staged pressure process begins, as disclosed above, first increasing pressure around the bag and the part to compress it preliminarily and to press or drive all trapped gas out of the bag, out past the wedge and into and through the socket; then secondly, to increase pressure in the press sufficiently to drive the wedge into the socket in full sealing engagement, so neither the bag, nor any part of the part, nor any of the pressure medium can be forced out the valve. This obviates the need for any kind of vacuum line inside the pump (which in any case would simply be crushed by the working pressure of the pump).

Multiple Bag Press

A press has a pressure chamber filled with a substantially incompressible medium and the medium at least partially encloses a plurality of elastomeric pressure vessels. Each vessel is adapted to be filled with a substantially incompressible fluid that is in fluid communication with a pressurized source of the fluid. The combined or net effect of the multiple pressure bags or vessels is substantially the same as have a single, much larger, bag in place.

In a Boroclave press and, in a clamshell type press in particular, there are generally two press halves; in one half a mold and workpiece are disposed and in another half a pressure bladder or bag is disposed. When the press is closed, raising pressure inside the bladder presses the workpiece against or into the mold to form the finished piece.

What is disclosed is a plurality of pressure bags rather than a single bag or bladder in a press. Sometimes working stresses on a single bladder or bag are such that the bladder tears or wears beyond working capacity and has to be replaced. Such bladders, especially if large or made to be subject to extremely high pressures and temperatures are very costly to replace and time consuming when they are replaced.

Press Closure and Pressure Reinforcement

### Sleeve Press Closure and Pressure Reinforcement

Many disclosures have been directed towards improved pressure vessel construction. Some deal with closure members for selectively sealing vessels capable of withstanding elevated pressures. In the field of isostatic presses and processes for using them, and especially in the area of hot isostatic presses (HIP), many improvements have also been suggested.

Pressure vessels used in HIP (and also in autoclaves or hydroclaves) require ready access to their interiors for placing and removing work pieces and tools. Thus, any closure device that seals such vessels must be relatively easy to open and close, and must be able to withstand the internal pressure of the vessel with no leakage of liquid or gas.

It is well-known that many HIP processes have serious problems in being too low in productivity, and many attempts have been made to shorten the cycle time period and to improve the efficiency of operation and use of HIP systems in general. See Japanese Laid-Open Patent Specification No. 51-124610 disclosing an improved HIP method and system.

Prior methods of meeting the two requirements of ready access and withstanding extremely high operating pressures internal to the vessel have proved both time-consuming and expensive, and sometimes not entirely effective. In one very old example, just to get into and out of a high pressure vessel, 70 long and thick bolts have to be removed and later replaced (and properly torqued of course, and usually more than once as pressure increases), and various pieces of “holding” ring and “shear” ring have to be removed and later replaced, parts of which require an overhead crane.

U.S. Pat. No. 3,992,912 to Jonsson issued on Nov. 23, 1976 discloses an isostatic press in which work pieces are enclosed in a pressure vessel filled with a liquid and closed by a lid (and discusses alternate approaches to opening and closing a pressure vessel). Jonsson's vessel is pressurized after it is placed in a frame adapted to absorb substantially vertical forces. The lid or top cover is moveable substantially vertically in relation to the pressure vessel after the vessel has been introduced into the frame. Other known isostatic presses fall generally into two categories.

The first category involves small diameter pressure vessels having lids which can be screwed into the pressure vessel. The other category is applicable to larger pressure vessels where the lids must be held in place or supported by another structure such as a rectilinear yoke or frame which can resist substantial tensile forces without significant deformation, for the additional support which is required. Such frames can weigh hundred of tons.

Use of such a frame requires that the pressure vessel be removed or at least pivoted from the frame each time a new workpiece is to be introduced to the vessel. Thus efficiency in loading and unloading the pressure vessel is lowered because of the need to remove the pressure vessel from the frame. All of these inefficiencies are magnified for very large presses, such as presses large enough to create a wind turbine propeller blade in a single press.

The disclosed subject matter addresses and provides a system that addresses all of these concerns in a novel way. The advances disclosed represent a departure from conventional wisdom so far about how to hold HIP presses closed.

### Sleeve Press Closure

A press has a cylindrical pressure chamber and two closable press halves that are held together by a plurality of slidable cylindrical bands that are slid into place over the ends of the press halves.

A very large Boroclave HIP is disclosed. Such a press can hold the composite laminate materials needed to create a very large composite structure all in one piece, for example a propellor blade for a large wind turbine (for example, with blade lengths of around 42 meters or about 140 feet). The press can readily and rapidly be opened to receive all these materials, and when closed, apply the necessary very high pressures to cause these materials to bond and transform into the kind of composite structures required.

As mentioned in the background, such a press must conventionally either be complex, or made of thick heavy steel, and/or surrounded by an enclosing frame. Alternatively, and novelly, it can be made relatively simply, and formed essentially of two semi-cylindrical hinged halves which, when closed, make a very long cylindrical bodied press. In a particular aspect of this press, when the two press halves are closed, and appropriately sealed, the two halves are held together by corresponding cylindrical steel bands that are slid into place over the ends of the now closed press halves.

The inner dimension of the bands is closely sized to be a close slip fit over the outer dimension of the closed press. It is believed that using a cylindrical construction allows stresses from inside the press to be evenly distributed over the entire circumference of the enclosing steel bands, such that, assuming there are no metallurgical anomalies, every bit of the bands receive the same strain. Thus, for a given internal press pressure, a dramatically much smaller metal mass is needed to hold the press halves closed, than if, say, a conventional steel framework were used.

Of course designs that are the same or similar to disclosed designs can also be applied to smaller presses as well, and to some degree to non-cylindrical shapes.

In a clamshell type press, particularly in a Boroclave or other HIP, the two press halves generally open along a long axis, and though the press halves themselves may not be hinged, the opening action is a long axis hingedly opening action (hinges, if any, remote from most of the press halves themselves). The disclosed sleeve press is an effective closure and pressure reinforcement mechanism for such presses, especially for very long presses (>20 feet long). The mechanism generally takes the form of sliding cylindrical bands.

### Interlocking Press Closure and Pressure Reinforcement

The disclosed press has a pressure chamber and a lid and a plurality of spaced-apart and hinged reinforcement arm pairs. Each arm pair wraps around the pressure chamber and lid when the arms are hinge dly closed. Each arm pair is rapidly openable to free the pressure chamber and the lid to open. Each arm pair is spaced from, yet connected to, each adjacent arm pair so that all arm pairs are opened and closed together in an action that is separate from the opening and closing of the press halves. For each arm set there is a bottom piece or underarm that spans the underside of the pressure vessel. There is also a hinge and two over-arms hinge dly engaged with and on opposite ends of the bottom piece. The over-arms when closed and locked, span one side of the pressure chamber and lid to hold them closed. The hinge on each side is optionally a metal rod that serves as common hinge for all the arm sets. A lock bar is separately carried and swung into position in its own cradle just as the arm pairs close. Desirably, the lock bar serves all arm pairs.

In a clamshell type press, particularly in a Boroclave or other HIP, the two press halves generally open along a long axis, and though the press halves themselves may not be hinged, the opening action is a long axis hingedly opening action (hinges, if any, remote from most of the press halves themselves). The closure and pressure reinforcement mechanism above with its sliding cylindrical bands is one approach to reinforcing such long presses.

It has been shown to be effective in maintaining pressure vessel integrity under extremely high pressures, though it can require significant open and closure time and maintenance, and has very demanding mechanical tolerances.

Another way of opening and securely closing a press or high pressure vessel, and especially a very long press or pressure vessel, is relatively less expensive, allows more open tolerances, and is much quicker to open and close securely.

A series of spaced and hinged reinforcement arm sets or pairs wrap around the pressure vessel when hingedly closed, but readily and rapidly open to free the pressure vessel to open when appropriate. There are enough arm sets to cover substantially all of the length of the vessel, as they wrap around the width of the vessel. Each arm set is desirably spaced from, yet connected to, each adjacent arm set so that all arm sets may be opened and closed together in an action that is separate from the opening and closing of the press halves. Each arm set has a bottom piece that spans the underside of the pressure vessel and two hinged over-arms that, when closed and locked, span and hold closed the upper side of the pressure vessel. Desirably, the hinging between these over-arm halves and their respective junctures with the bottom piece, are with two very large steel rods that serve as common hinge for all the arm set pairs, one rod engaging each side of the bottom piece.

Deep Draw and Vacuum Active Stretch

Method and apparatus for enhancing ballistic properties of composite parts by active stretching of materials during a deep draw high pressure process are disclosed. Active vacuum stabilization of materials during heating and pressing is also disclosed.

Conventional examples of this kind of press may be found in Pryer Technology Group's Triform Hydroform Presses (see URL link above). Such presses however are believed to be entirely closed when locked, and allow no part of the workpiece to be outside of the press when the press is closed. Such presses also do not use any kind of active vacuum process for their workpieces.

### Deep Draw and Deep Draw Preform

A method of making a composite article has the steps of stacking composite materials and preheating them, preforming the stacked and heated materials inside a deep draw press (but not consolidating the materials); and then in a later and separate step consolidating the preformed materials into a composite article under isostatic pressure and heat.

In one kind of conventional deep draw press a work piece is positioned between a conventional movable deep draw forming die and an expandable bladder generally filled with fluid under pressure. This is sometimes referred to as a hydrostatic deep draw. The forming die is operated by a conventional ram cylinder and the bladder is some kind of a isostatic pressure vessel, all in a lidded, lockable pressure vessel.

In general, the vessel locks closed trapping a work piece, typically sheet metal, then high pressure is applied to the bladder from one side pinning the material to a flat platen on the other side. Once the material is under pressure the hydraulic ram with a mold piece mounted on it is forced up through the bottom of the platen. Under full pressure the ram displaces liquid in the pressure chamber and in the process draws the flat material into a deep and complex shape. Deep draw in this kind of application generally refers to any draw where the depth of the draw is greater than half the diameter of the finished piece (also sometimes where the depth is greater than the diameter of the piece). Then the pressure in the bladder or isostatic vessel is lowered, the ram is retracted and the vessel is unlocked and opened to remove a finished formed part.

Conventional high strength, low weight structural ballistic composites are made from sheets of woven fiber materials such as fiberglass or graphite. The composite article is typically made of multiple layers of such material, sometimes combining one or more types of material. Conventionally such stacks of composite fabric are laid up over a mold or die and thereafter cured under selected temperature and pressure conditions. When deep draw processes are used to form and shape and optionally cure such ballistic composites, there are important new considerations.

High density polyethylene (HDPE) ballistic cloth fiber and other UHMW thermoplastic fibers, such as polypropylene or the like, are generally pre-stretched in the threading and weaving process by which they are formed into cloth to only around 30% of their theoretical or potential length. When such fibers are created and before they are woven, the molecules of the fiber are twisted and randomly arrayed. This works for soda bottles and cutting boards, but the material is far from ballistic at that point.

When this material is threaded, pulled tight and spun to produce basic ballistic cloth, the molecules are stretched into alignment, at least partially, and this gives the fiber considerably more strength. But it is still only about 30% of what is believed to be attainable by methods disclosed below.

When such conventional woven ballistic cloth fibers (which may also include Spectra and Dyneema brand UHMW fibers or the like) are heated without any pressure stabilization, they revert to random twisted form and strength is lost.

In a novel preform process, which is advantageously step one of a two step process, a stack of composite material is preformed in vacuum around a complex shape, in advance of any pressing to be optionally employed (in step 2, for example).

### Vacuum Active Stretch

A method of making a composite article has the steps of stacking or laying up composite materials inside a vacuum bag, drawing down an active vacuum on the bag (with the bag releasably connected to a source of vacuum) and heating or pre-heating the bag under continuing active vacuum. The vacuum bag is desirably sealed with a plug and socket valve mechanism wherein the plug and socket members are reciprocally matching. The socket member in fluid communication with the active vacuum. The plug member is displaced from the socket member at least partially for fluid flow around the plug until a pressure on the plug side of the seal drives the plug into the socket.

A method of making a composite article has the steps of stacking or laying up composite materials inside a vacuum bag, drawing down an active vacuum on the bag, heating the bag under continuing active vacuum and, while still under active vacuum, placing the bag and materials in a deep draw pressure vessel and deep drawing (but not necessarily consolidating) the materials to create an active stretch within the material fibers. The heated material fibers are thereby stretched substantially beyond the conventional 30% stretch achieved in the weaving process.

Surprisingly, when such ballistic cloth is further actively stretched, under vacuum and heat, far greater ballistic strength is achieved in the finished composite article. Active stretch means the cloth is further stretched even while it is already hot and being pressed under ballistic forming pressures in a Boroclave or other HIP, particularly a deep draw variation of one of these presses.

It has also been discovered that even a 14+ psi vacuum is enough pressure to maintain the stability of the fibers (otherwise lost as described above when such fibers are heated without any pressure stabilization), and that placing the workpiece assembly inside a vacuum bag and drawing a conventional vacuum on the bag and the workpiece before heating them adequately maintains the strength of the ballistic fibers and stabilizes them for further strength development through active stretching

A composite part layup or stack of ballistic cloth material of selected composition and number of layers is disposed inside a conventional high temperature vacuum bag and sealed in with a vacuum valve, preferably of the quick release type, and an active vacuum is drawn down on the bag and maintained with releasable connection to the vacuum pump or other vacuum source. The bag and the composite materials inside the bag are heated in an oven or heating device under continuing active vacuum.

The novel variation in the press is a gap or other like structure in the enclosure or lid that allows part of the bag containing the vacuum valve at least, to hang out of the press, so that active vacuum is maintained on the composite during the entire operation. The pressure vessel is then closed, except for the part of the bag remaining outside, and the normal deep draw cycle is performed to create an active stretch within the ballistic fibers while the active vacuum is maintained on the composite until the cycle is effectively completed.

A novel variation in this process is to employ a two stage pressurization of the deep draw press. The first stage is to temporarily seal the vacuum bag. The second stage is full pressure in the isostatic pressure chamber and then activation of the deep draw ram. The ram forms the part shape and does so with attendant active stretching in the workpiece.

In some processes a novel ring seal having a dished cross section is laid, dished side up, over the laid up workpiece stack of materials to help contain the material of the isostatic pressure chamber bladder, typically urethane or silicon, which is potentially deformable and squeezable right out through the novel gap. The press is closed, optionally heated, or already heated, and pressurized in two stages. During the first stage, while there is still a gap in the press enclosure opening, the dished ring seal is activated and contains the bladder material to keep it from being pushed out the gap in the press.

As this method enables the composite material to be heated outside of the press there can be a large number of parts preheated in advance and prepared for rapidly cycling through the press. Preferred deep draw presses are also HIP or Boroclave presses, though it is believed that unheated presses, since the material is already preheated, may also be employed to some effect.

It is also believed that pulling air and volatile gasses out of an advanced composite stack of materials produces superior composites, so the active vacuum also allows for advanced composites to be formed rapidly in a hydrostatic deep draw device or hydro forming machine, hydroclave, Boroclave or deep draw Boroclave, while also developing the maximum possible ballistic properties in the finished composite. This method advantageously employs a machine from which part of the vacuum bag may protrude or remain outside the machine during and after the vessel is locked and fully pressurized.

The disclosed vacuum preheat process may advantageously be employed regardless of whether the press is a deep draw press or not. A Boroclave or conventional HIP may be employed to press composite layups with suitable fixed (as opposed to deep draw) mold pieces, and still obtain all the disclosed advantages of active vacuum bagging and preheating.

Particular and further active stretch advantages are achieved however with a deep draw process. The heated cloth and its fibers are further stretched (beyond the conventional 30% stretch achieved in the weaving process as explained above) as they are further drawn into the deep draw configuration. It is believed that such active stretching increases ballistic properties by as much as an additional 50% to 100% over similar material that is pressed but not actively stretched while pressing.

Once the part is at the desired temperature, the vacuum bag and its contents are removed from the oven and placed in a novel variation of deep draw pressure vessel, still under active vacuum.

### BRIEF DESCRIPTION OF THE DRAWINGS

FIG. 1 is a schematic illustration of an embodiment of the disclosed press.

FIGS. 2A-2D are schematic illustrations of an aspect of the operation of an embodiment of the disclosed press.

FIG. 3 is a schematic illustration of a liquid media embodiment of the disclosed press.

FIGS. 4A-4B are schematic cross sectional elevations of gasket edge designs showing embedded ring and press closure sealing surfaces.

FIGS. 5A-5C are schematic illustrations of bladder prior art modes.

FIGS. 6A-6B are schematic illustrations of aspects of bladder intelligent slitting.

FIG. 7 is a schematic illustration of an embodiment of a wedging gasket for the disclosed press.

FIGS. 8A-8B are schematic illustrations of an embodiment of an active sealing floating gasket for the disclosed press.

FIGS. 9A-9B are schematic perspective views of a press reinforcement system.

FIGS. 10A-10C are isometrics of an alternate press reinforcement system.

FIGS. 11A-11B are schematic illustrations of the locking mechanism of FIG. 10.

### BEST MODE OF CARRYING OUT THE INVENTION

Turning now to the drawings, the disclosed press and method are described in illustrative embodiments by reference to the numerals of the drawing figures wherein like numbers indicate like parts.

Wherever used throughout the disclosure and claims, the term ‘generally’ has the meaning of ‘approximately’ or ‘closely’ or ‘within the vicinity or range of’, The term ‘generally’ as used herein is not intended as a vague or imprecise expansion on the term it is selected to modify, but rather as a clarification and potential stop gap directed at those who wish to otherwise practice the appended claims, but seek to avoid them by insignificant, or immaterial or small variations. All such insignificant, or immaterial or small variations are intended to be covered as part of the appended claims by use of the term ‘generally’.

### Basic Boroclave

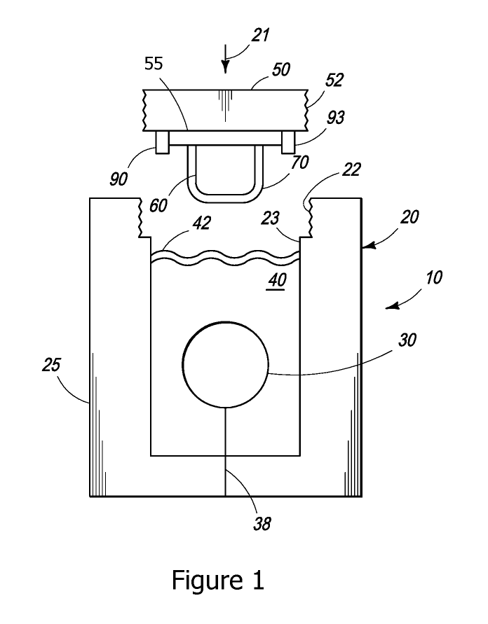

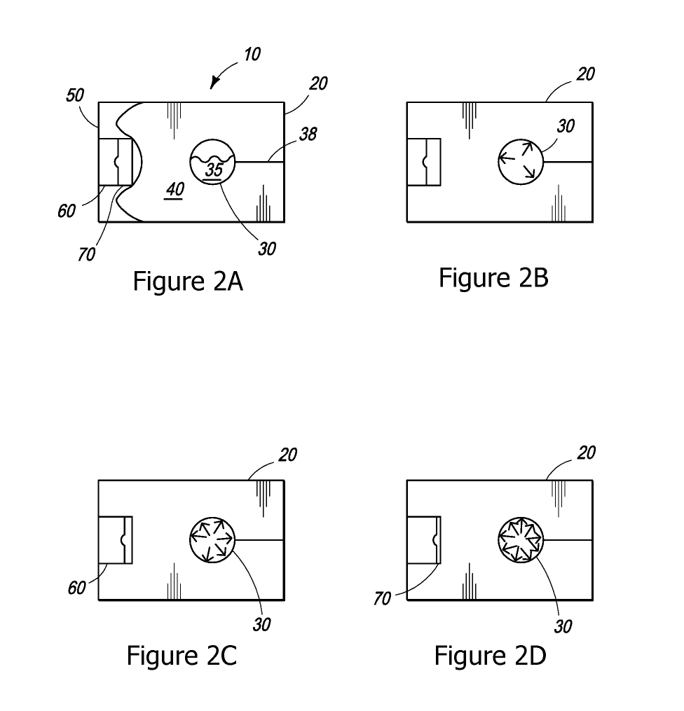

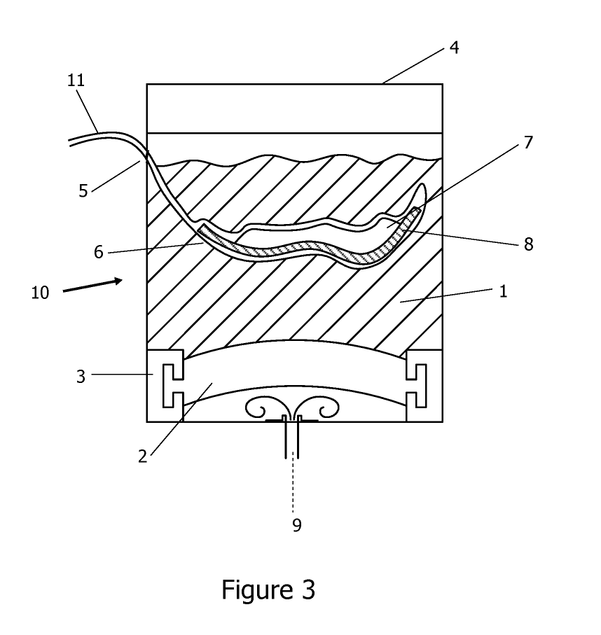

FIGS. 1 and 2 schematically illustrate an example of the disclosed press. The arrows inside vessel 30 schematically and graphically illustrate increasing pressure as the fluid 35 is pumped into vessel 30 via conduit 38 from a high pressure source of the fluid (not shown). The increasing number of such arrows from FIG. 2A in sequence to FIG. 2D is a kind of graphic schematic scale to illustrate that as fluid is pumped into vessel 30, and the fluid pressure goes up, the work piece or formable part 70 is subject to greater and greater pressure through the pressure transfer medium 40.

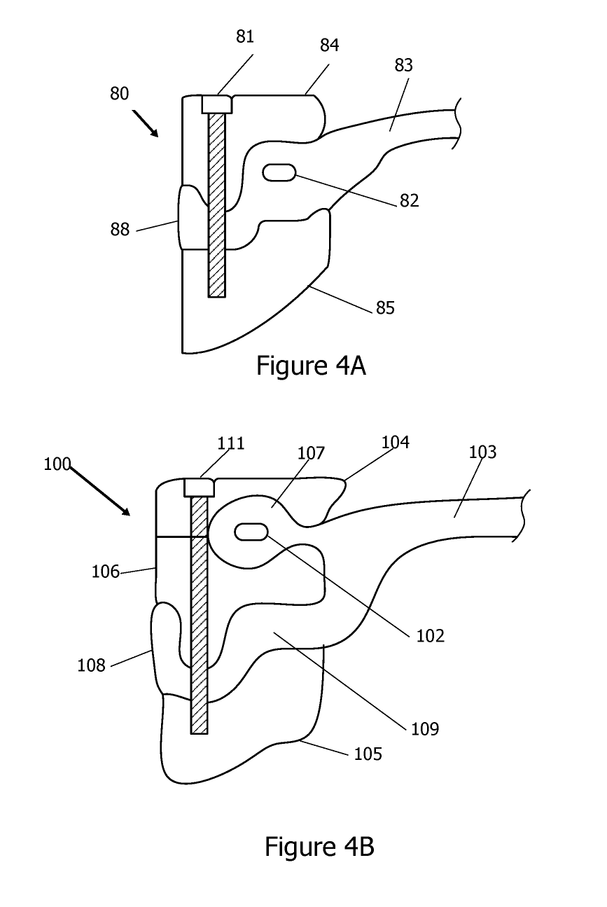

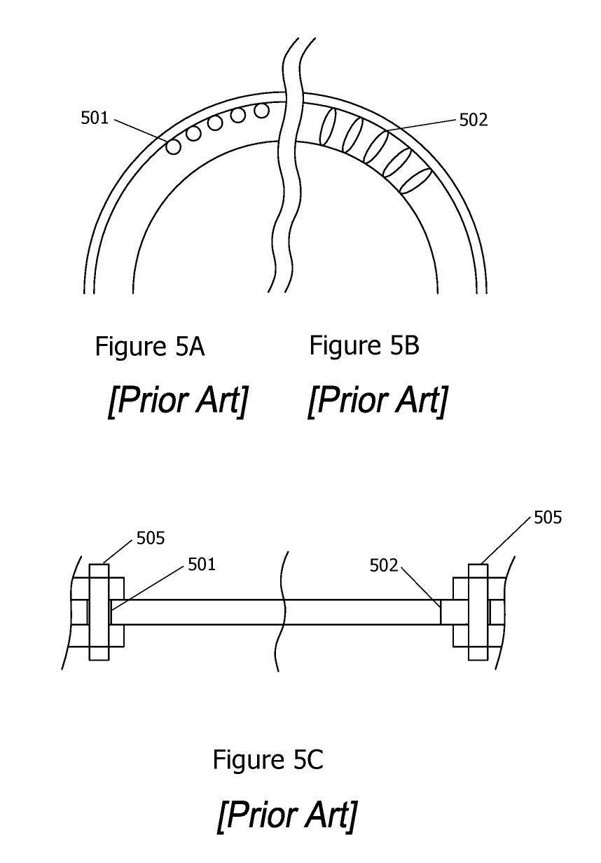

In FIG. 1, press generally shown at 10 has pressure chamber generally shown at 20 with chamber wall 25. Chamber 20 has sealing surface 23 machined as part of wall 25 for mating with (outer) sealing surface 93 of gasket or seal 90. Lid 50 is threadably and lockably engaged onto and into chamber 20 in the direction of arrow 21, and lid threads 52 mate with chamber threads 22. Disposed on an inner surface of lid 50 is platen 55 which is desirably adapted to be rapidly heated and cooled (see FIG. 5), and upon platen 55 is mounted mold 60 over which is work piece composite layup or pre-preg 70. Chamber 20 is nearly filled with pressure transfer medium 40 (generally solid silicon but optionally particulate silicone spheres or crumb-balls 41), in the middle of which is embedded elastomeric pressure vessel 30. See also discussion of particle making in U.S. Pat. No. 4,670,530 to Beck, which is hereby incorporated by reference as if fully set forth. When vessel 30 is first filled from conduit 38 and then pressurized (see FIG. 4), vessel 30 expands slightly to move the pressure transfer medium into pressing position by taking up all space not occupied by mold 60, work piece 70 and platen 55. Optional barrier 42 is disposed between transfer medium 40 and work piece 70. As pressure in vessel 30 increases with increasing pressure of fluid 35, the pressure is, in hydraulic-like fashion, transmitted outward equally in all directions to press against wall 25 and to compress work piece 70 against mold 60, gradually deforming and compressing piece 70 into the desired part.

A preferred transfer medium is a solid cast platinum cure silicone matrix or a silicone bead of varying size from 1 mm to 40 mm with a number of different sizes advantageously used at once. The silicone may advantageously be a metal powder admixture, especially where thermal conductivity of the medium is advantageous. Example metal powders may be copper or aluminum powder.

Tests show that very even distribution of pressure over the entire surface of the part is available with the disclosed press, enabling optimal performance of composite completion even in complex forms. Disclosed presses are designed to operate at extremely high pressures, ranging from 400 psi to 8500 psi and sometimes a high as 20,000 psi (2.8 to 59 MPa and sometimes as high as 138 MPa, respectively).

On the subject of cost, on the new press market a hydraulic press is a good deal at $0.21 per psi applied. A hydraulic press on the used market is on the low side $0.11 per psi applied. The disclosed press comes in at about $0.05 per psi applied, or one quarter the price of a new hydraulic press and half the price of a used press. With the disclosed press a finished part may be removed and a new part loaded in as little as 5 minutes, as in a 1 pound AD layer spectra shield or Dyneema HB series composite.

On the subject of safety, in the disclosed press there is no volume of built up pressure, meaning in the unlikely event of a chamber failure there is no explosion of gas just a rapid shredding of the transfer matrix and a elastomeric gel is extruded at low velocity. Since the pressure itself presents a minimal danger, the remaining risk is the various moving parts. The lid is advantageously mechanically locked in the up or open position so that in the event of a hydraulic line failure the lid is incapable of moving.

Disclosed presses are advantageously modular systems, with common and standard parts. For instance, all bolts are desirably common sized grade 8, and most fittings are of common size and availability. Presses are preferably constructed of x-rayed a36 alloy plate with 3130, 4140, 4340 and h13 alloy parts.

An example locking press pressure chamber has 4 sections of threaded structural tube and a mold plug. The inside diameter (ID) of the pressure chamber is 17.75 inches (45.08 cm) with an outside diameter (OD) of 20.0 inches (50.8 cm). A flange is threaded onto the pressure chamber and a collar fits over the flange and locks onto the mold plug using artillery breach screw threads. The mold plug is sealed to the pressure chamber with a metal ring seal.

In the pressure chamber having a threaded connection to the pressure chamber flange, the connection is loaded in tension. The threads for example are UN standard form with a pitch of 0.125 inch (0.318 cm). They have a mean diameter (Dm) of 19.75 inches (50.17 cm) and a thread length (L) of 6.0 inches (15.2 cm). The pressure chamber flange acts as a shear member that the collar flange is loaded against when tightening the pressure chamber onto the mold plug. The pressure chamber flange is tightened against a shoulder to locate it along the axis of the pressure chamber. The threads have the same stresses as the threads on the pressure chamber. The pressure chamber is loaded in shear by the collar flange with the full 10 million pounds across its length at the shear diameter of 20 inches. The shear area for this is 376 square inches. A locking collar flange has an inside diameter of 20 inches. The connection to the collar is threaded using UN standard thread form with 0.25 inch pitch and a mean thread diameter of 22.625 inches with a pitch of 0.250 inch. It is threaded into the collar and is the means by which the connection alignment is adjusted. It is 6 inch long and its shear area is 424 square inches.

Artillery screw threads are desirable and have a modified thread designed to handle loads in one direction only. The loaded thread face is 5 degrees from perpendicular to the axis. This decreases the chances of seizing due to decreased “wedging”. The artillery thread form is also stronger because when loaded, the threads will not attempt to dilate the collar which would decrease the shear area of the threads. The pitch for these threads is 0.5 inch. The face that is not loaded is at a 30 degree angle from perpendicular to the axis. The 30 degree angle allows the root to be thicker and decreases the bending stress on the screw. The artillery threads are shaved off at every ⅛ of a rotation until just under 50% of the thread is remaining. This allows the threads to be completely engaged after ⅛ of a rotation; increasing production efficiency. To allow for engagement/disengagement while the seal is fully seated the threads are advantageously spaced about an extra 0.1 inch (about 0.25 cm) apart.

The locking collar is machined from structural steel tubing with a 26 inch OD and a 2 inch wall. The minimum area loaded in tension is at the relief for the threading operation of the preferred artillery threading. This diameter is 23.55 inches giving a tensile area of 95 square inches. This is believed to result in a tensile stress of 105 ksi. The threads attaching the locking collar flange have the same stresses as those on the locking collar flange.

The mold plug seals against the pressure chamber and has the attachment fittings for an aluminum mold. The mold plug is loaded axially against the artillery threads and experiences the same shear loads as the locking collar.

### Liquid Media

In FIG. 3 pressure vessel 10 has lockable closing lid 4 and is filled nearly full with liquid medium 1. Liquid media are selected from corn starch, water, oil, silicone marbles, or the like. At the end of vessel 10 opposite lid 4 is rubber plug or bladder 2 which is exposed on a side away from liquid medium 1 to a source of pressure 9 which is advantageously a kind of hydraulic pressure. Bladder 2 is mounted in vessel 10 with clamps or gaskets 3. Thin tool 8 is advantageously made from composite, but may also be wood, plastic, metal, ceramic, or the like. Composite part 7 is laid up on tool 8 and the two pieces are enclosed in vacuum bag 6, the draw line 11 for which leaves vessel 10 via floating gasket 5.

Note that floating gasket 5 allows the draw line of bag 6 to escape the locked vessel while still allowing the bag to maintain an active vacuum, at least until pressures reach a level that starts pressing the composite into the tool and pushing the floating gasket closed. This kind of gasket “floats” by virtue of not being attached to the vessel, but is instead in sliding engagement with the wall of the vessel, and is responsive to pressure inside the liquid medium portion of the vessel so that the gasket moves to a relatively more closed position as the pressure in the vessel increases.

Warm water or cornstarch are preferred media, as this is believed to give the ability to pre heat part 7 (and optionally tool 8 and bag 6) then drop them into media 1, close lid 4, and pressurize bladder 2 at bottom of the vessel 10. This in turn is believed to ameliorate two potential vessel problems: 1) material leaking out and leading to bladder failure, 2) having to cheaply form a huge variety of shapes with low allotment of budget for tooling.

### Rippled Guide Deep Draw

### Example:

Using 34 layers of DSM Dyneema HB 80 sheet material, preheat material to 250 degrees. Place a sheet of Spectra cloth under the HB 80. Place the preheated sheets on top of the female mold with its generally conical ring shaped female ripple cut guide. Place a second sheet of Spectra cloth on top of the HB 80. Engage a corresponding male ripple cut guide (desirably made from polyethylene) on top of the HB 80 and Spectra cloth.

Using a clamp, hold the two ripple cut guides tightly together. Clamping force is desirably adjusted to the point where the ensuing male mold press step just draws sheet material smoothly and without damage through the ripple guides without hesitation or snagging. Once the ripple cut guides are clamped, pass the male mold through the center of the ripple cut guides, smoothly and evenly drawing the material through the clamped guides and pressing the HB 80 material into the female mold. Hold under pressure until the HB 80 cools. This process creates a shell that can then optionally be further processed utilizing omnidirectional pressure from a Boroclave or other HIP press to finish the composite.

Other materials can be drawn in the same fashion, for example HB 26, HB 80, Honeywell 3130, Honeywell 3124, or combining polyethylene sheets such as Honeywell products and Dyneema HB 26, 50, and 80 with Kevlar products to draw composites with rigid interiors and semi rigid cores.

### Offset Preform Deep Draw

### Example:

Using a stack of 34 layers of DSM Dyneema HB 80 sheet material, preheat material to 250 degrees. Place the preheated sheets on top of the female mold. Pass the male mold through the center of the stack smoothly and evenly drawing the material down into the female mold. Hold under light pressure (well below consolidation pressures) until the stack cools. This process creates a shell that can then be further processed utilizing omnidirectional pressure from a Boroclave or other HIP press to consolidate and finish the composite.

Other materials can be drawn in the same fashion, for example HB 26, HB 80, Honeywell 3130, Honeywell 3124, or combining polyethylene sheets such as Honeywell products and Dyneema HB 26, 50, and 80 with Kevlar products to draw composites with rigid interiors and semi rigid cores.

### Bladder Technology

Bladder Gasket with Embedded Ring

Two improved rubber bladder gaskets are disclosed. Also disclosed are press half mating surface designs in Boroclave sealing areas that correspond respectively with, and are designed to retain, each respective disclosed bladder gasket. See FIGS. 4A and 4B.

In FIG. 4A a first bladder gasket design 80, its outer edge 83 is molded and shaped to fit into a correspondingly shaped metal sealing space between two press half mating surfaces 84 and 85 (held together with bolt 81), and there is a preferably metal ring 82 pre-cast into an inner part of outer edge of the bladder gasket 83, inward of outer lip or edge 88, for extra durability of the gasket edge in the clamped metal sealing space of the Boroclave.

In FIG. 4B a second such bladder gasket design 100, has two distinct outer lips or edges, both of which are shaped to fit into corresponding shaped metal sealing spaces between press closure mating parts 104 and 106, and between press closure mating parts 106 and 105 (all held together with bolt 111). There is a preferably metal ring 102 pre-cast into a first lip or edge 107 of bladder gasket 103 for even more durability of the gasket edge in the clamped metal sealing space between sealing parts 104 and 106.

In both of these bladder gasket designs 80 and 100, as the bladder is stretched under working pressures to conform to the shape of the work piece on the mold, the material of the bladder is necessarily and correspondingly thinned as it stretches. For reasons that would not appear to need elaboration for those skilled in the art, the most critical area of such thinning of the bladder material is just inward of the metal clamping or sealing areas of the press. Critical thinning at these points can result in failure of the bladder gasket and corresponding failure of the press.

The gasket design 80 is believed to be an improvement over conventional sealing gasket designs, in that thinning of the gasket material at the sealing areas does not necessarily result in a pulling of gasket 83 from the sealing edges, as embedded ring 82 tends to hold the gasket material within the sealing spaces, even when it is critically thinned. A second, more distal, gasket material mass at lip 88 is also held within the sealing area and is believed to be subject to little or no thinning, as embedded ring 82 takes the residual tension of the stretch of the gasket material under pressure, without transmitting the stretching any further to the outer lip 88 of the gasket material. If stretching and damage to the gasket material is extreme however, then it is believed the most likely mode of failure is a silicone leak along the thinned gasket material in the sealing area, past the ring area, and out to the outer edge of the gasket.

The second gasket design 100 addresses such extreme conditions advantageously. Gasket lip 107 with embedded ring 102 is separate from and relatively independent from second gasket mass 109 with lip or edge 108, that goes all the way to the outside of the sealing area. Thus any stretching and thinning forces are first and preferentially applied to lip 107 reinforced with the ring, in manner like as described above for the first gasket design. That is, the material around the ring may thin, but it does not pull out, since it is held in place by the ring. Meanwhile, the other lip 109 of gasket 103 receives relatively far less of the stretching and thinning forces and therefore is subject to little if any thinning And if partial gasket failure occurs at extreme conditions, the failure occurs at the lip with the ring, and silicone penetrates the gasket, but does not escape the press. This is especially aided in embodiments where the outermost mating sealing surfaces advantageously define a tortuous path (see space between parts 105 and 106) for the second lip or edge 109 of gasket 103.

Dual Form Deep Draw Bladder

### Example

A dual form bladder is co-molded to have both a urethane and a silicon compound layer. There is a workpiece facing layer made of urethane, and an inner layer that is exposed to the heated fluid of the pressure chamber that is made of silicon. The two layers are installed together to seal the pressure fluid chamber so they act as a single bladder or plug. Alternatively, the two layers are bonded together

Intelligent Slitting

FIGS. 5A-5C are typical of prior art bladder installations using bolts, and through-holes in the bladder edges for the bolts, to hold the bladder in place in the press. In FIG. 5A the unexpanded or resting hole shapes 501 are shown (bolts not shown for clarity of illustration). On the right side of the figurative dividing line, which is denoted FIG. 5B, the distended, expanded or stressed hole shapes 502 are illustrated, which result from considerable bladder deformations. FIG. 5C is an alternate schematic cross-section of the same bladder, again with unexpanded hole 501 on the left and expanded hole 502 on the right. This time the bolts 505 are shown for reference in illustrating the relative hole deformation on the right hand side of the figure.

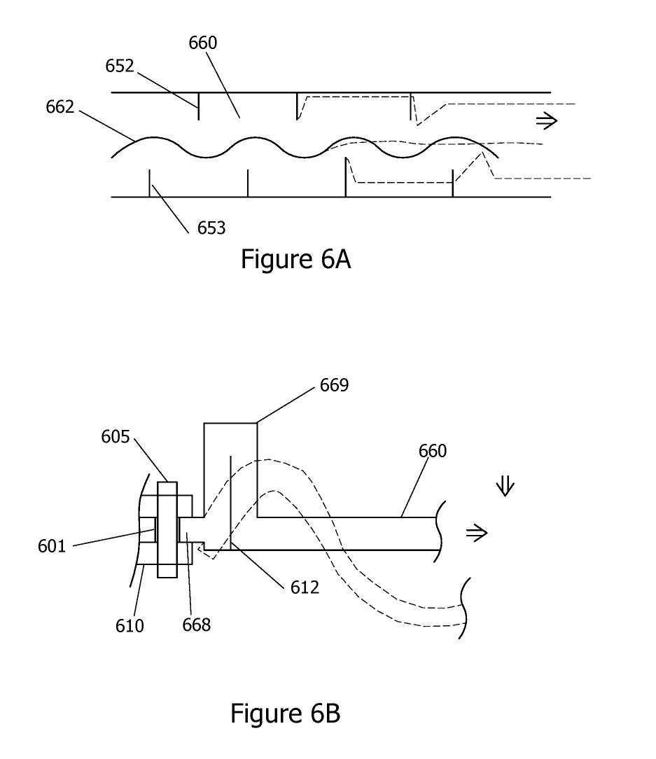

FIG. 6B schematically illustrates an otherwise conventional bolt 605 and through-hole 601 attachment of a bladder edge 668 of bladder 660 at the bladder edge attachment point 610 in the press. However, it can be seen that inboard of the attachment point there is a mass 669 of bladder material with a slit 612 that is slitted in such a way that, upon commencement of bladder deformation, bladder mass 669 is pulled gradually into the shape denoted by the dotted lines in the figure. It can be seen that, under the influence of the deformational forces (generally in the directions of the arrows shown), slit 612 is widened, gradually at first, and bladder mass 669 assumes a more rounded shape as bladder material is pulled in the direction of the deformational forces.

Surprisingly, such a slitted-mass arrangement relieves most if not all of the stress on the bolt through-holes, which therefore in turn experience almost no deformation at all, or at least no significant deformation. The result is that pressure medium, whether oil or silicone, does not leak out from deformed through-holes around the bolts at the attachment points; rather, the through-holes around the bolts continue to perform their inherent sealing function without loss of performance through deformation.

FIG. 6A schematically illustrates an alternate bladder cross-section. Instead of the slitted peripheral bladder mass of FIG. 6B, bladder material 660 has slits 652, 653 at concentric or peripheral intervals from the bladder edges (not shown). Advantageously, slits 652 in the notional top of the bladder, or above the bladder, are offset from slits 653 in the notional bottom of the bladder, or below the bladder, and wavy parting line 662, formed during the making of the bladder, is such that as bladder 660 is stretched with deformational forces (generally in the direction of the arrow shown), slits 652, 653 are widened as shown by the dotted lines, and wavy line 662 is straightened. References to top or bottom of the bladder or above and below are all understood to be relative and for discussion purposes only, as the bladder can be installed in any orientation suitable to the particular press.

Not illustrated is a top view or plan view pattern of slitting, for instance in the embodiment depicted in FIG. 6A. One variation in plan appearance is for the various slits that are shown in this figure to be more or less concentric rings of slits (ie in a roughly circular bladder, the slits would be rough circles). Another variation is for the slitting to be roughly wavy lines and still roughly concentric in plan view.

In each illustration, the bladder material is resilient enough so that as deformation forces are abated or relieved, the bladder and its slitting reassume their pre-deformation configurations, and this deformation/relaxation cycle can be repeated many times without damaging the bladder.

### Active Sealing, Wedging Gasket

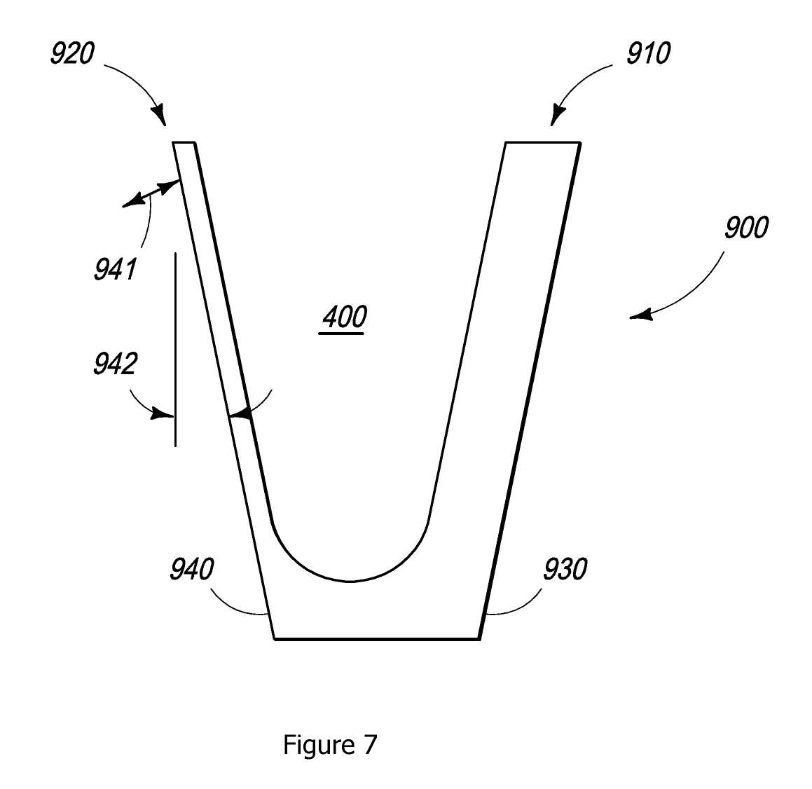

In FIG. 7, wedging gasket shown generally at 900 has outer relatively rigid member 910 with surface 930 that is in mating press fit relationship to the vessel or lid (not shown) to be sealed, and another slightly angled inner slightly resilient member 920 with mating surface 940. Member 920 is desirably at angle 942, where angle 942 is the smallest working angle needed to effect the fit and release of the gasket with the venting properties disclosed herein. Appropriate working values for angle 942 have been found to be in the range of 6 to 45 degrees and more particularly 8 to 12 degrees. The space or void between gasket member 910 and angled member 920 is filled with silicone 400 or other substantially incompressible but elastomeric medium. In operation, as the lid is closed or the pressure chamber is otherwise closed, angled inner member 920 is preliminarily mated with its respective sealing surface. Then after initial compressing pressure is applied inside the chamber and trapped or entrained gases such as air are vented out through the gasket's not yet perfect seal, the transfer medium (not shown) is pressed against silicone 400 and it in turn slightly deforms angled member 920 in the direction indicated by arrow 941 into an increasingly perfect interference fit with the respective mating surface (not shown). When the pressure in the chamber is reduced, and the corresponding pressure in silicone 400 holding angled member 920 against its respective sealing or mating surface is released, angled member 920 springs back to its un-pressured configuration and dimension in the other return direction indicated by arrow 941.

### Active Sealing, Floating Gasket

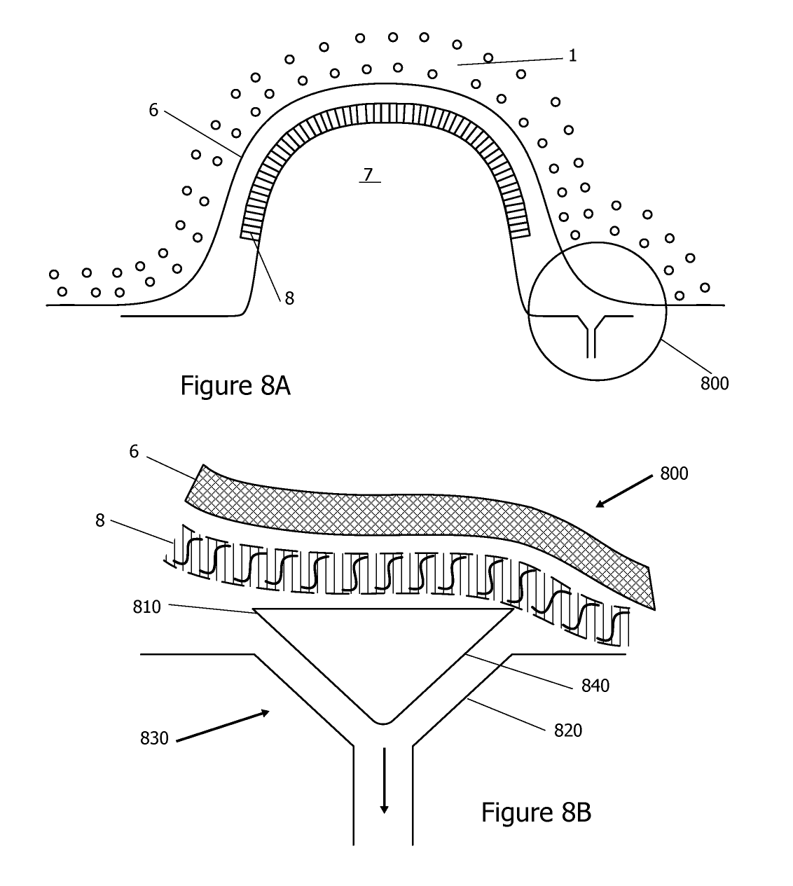

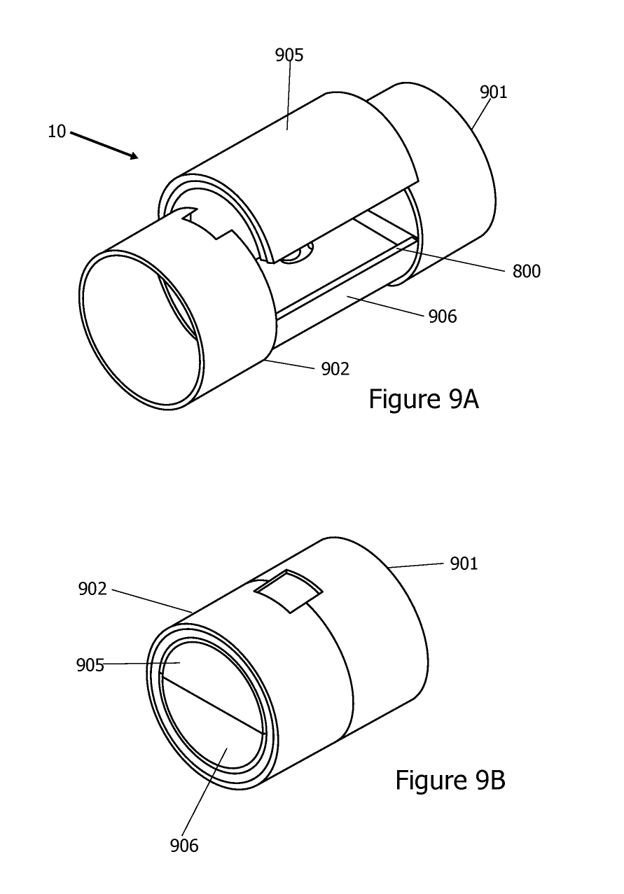

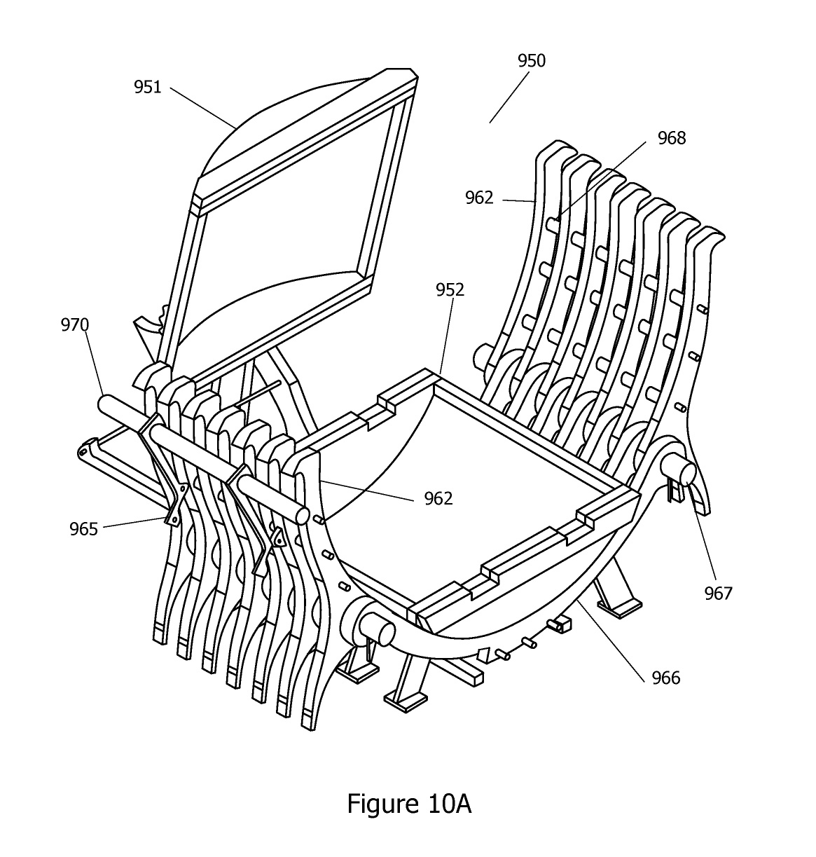

In FIG. 8A and detail FIG. 8B, floating gasket 800 has plug 810 and mating socket 820 mechanism that work together as escape valve 830 for trapped gasses. Floating gasket 800 and socket 820 are generally circumferential in the press (see also FIG. 9A) and shaped and sized in cross-section to suit the shape of plug 810.

Where floating gasket 800 is in the form of single point escape valve 830, such as for use in vacuum bagging, as illustrated, plug 810 is desirably in the form of a frusto-cone (truncated cone).

One surface of the plug or socket is knurled lightly or just mechanically roughed a bit. These rough surfaces 840 impose no significant barrier to the release of air through the valve, and as pressure is increased, the knurling or roughness is crushed into an effective sealing surface so pressure medium cannot escape.

Plug and socket escape valve 830 is shown in conjunction with a modification of an otherwise conventional vacuum bag 6 (see also FIG. 3). Modified bag 6 has a plug 810 and socket 820 incorporated into it, such that the plug can be fitted into a socket surface in an outer wall or floor of the press, or alternatively built into the mold piece itself. Composite part 8 is bagged and plugged into an available socket, and then the staged pressure process begins, as disclosed above, first increasing pressure in pressure medium 1 around bag 6 and part 8 to compress it preliminarily and to press or drive all trapped gas out of the part and bag, out past plug 810 and into and through socket 820; then secondly, to increase pressure in the press sufficiently to drive plug 810 in the direction indicated by the arrow into socket 820 for full sealing engagement

### Multiple Bag Press

### Example

In a Boroclave that has two halves, instead of a single bladder or bag in one half, there are multiple pressure bags, each bag in communication with a source of pressurized fluid. The bags are of sufficient number and arranged optimally so that when pressure inside them is increased to working press pressure, they press into each other and against the workpiece to present a substantially unvarying pressure surface against the workpiece. In other words, substantially the same as if there were but a single bag.

Then, in the event of wear or failure of a single bag, the single bag is replaced, and at a fraction of the cost and time of replacing a single large bladder.

### Press Closure and Pressure Reinforcement

Sleeve Press Closure and Pressure Reinforcement

FIGS. 9A-9B are schematic perspective views of long press 10 having upper and lower hinged closing halves 905 and 906, and sliding closure bands 901 and 902. Hydraulics and track sliding mechanism for bands 901, 902 are not shown. FIG. 9A shows press 900 open and bands 901, 902 open; FIG. 9B shows press 900 close and bands 901, 902 closed to cover the press halves.

Interlocking Press Closure and Pressure Reinforcement

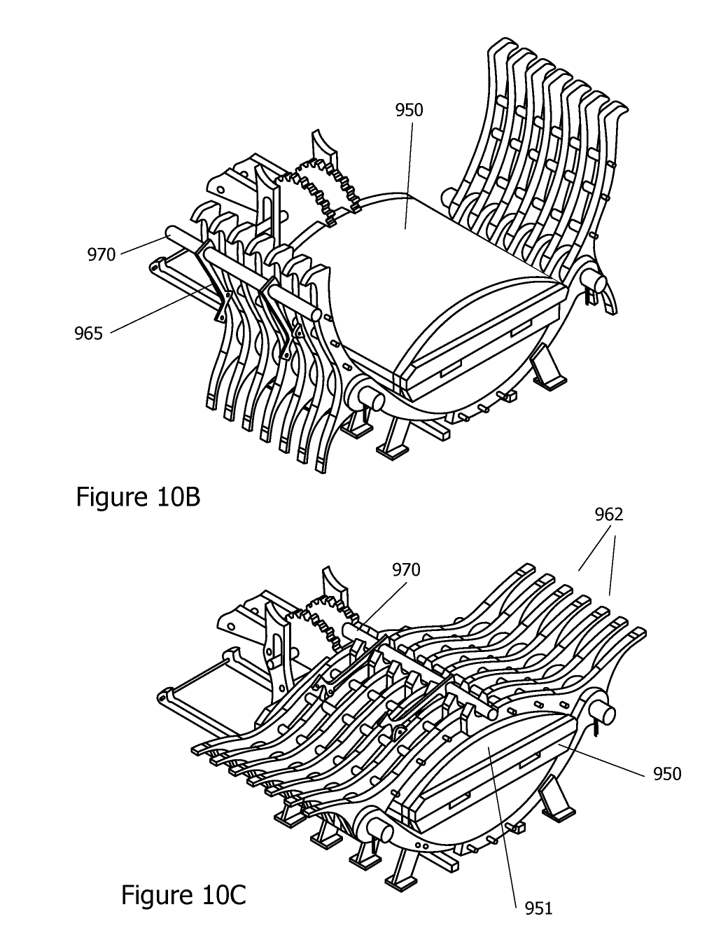

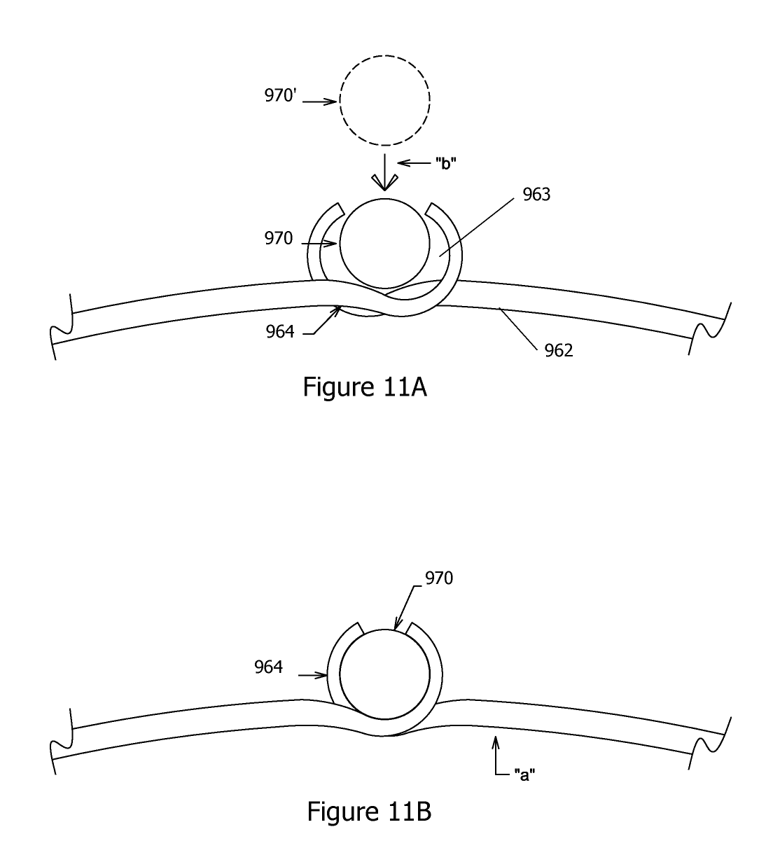

The opening and closing actions of long press 10 and its sets of interlocking reinforcing arms 960 may be seen in FIGS. 10 and 11. In FIG. 10A both press halves are open and the reinforcement arm pair sets are open; in FIG. 10B, the press halves have closed, but the arms sets are still open; and in FIG. 10C, the reinforcement arm sets have closed and locked.

Pressure vessel 950 has press halves 951 and 952. An interlinking reinforcement overarm structure has arm sets that include underarm 966 and an overarm pair that includes two overarms 962. Each overarm 962 has a hook end for receiving the lockbar, and a hinge end where it is hingedly engaged with underarm 966 with hinge rod 967 or the like. Desirably all arm pairs are movable in unison and are connected together with overarm rods 968 or the like.

FIGS. 11A and 11B are details of the interaction between reinforcement arm pair and it's lock bar. Over-arm pairs 962 lay loosely overlapped above pressure vessel 950. Lockbar 970 fits readily into channel space 963 between respective arm hooks 964, dropping from position designated as 970′ generally in the direction indicated by arrow “b”. As upward pressure, generally in the direction of arrow “a” from slightly moving vessel lid 951, pushes over-arms 962 slightly upward, most or all of the available free channel space 963 is taken up, and hooks 964 closely engage lockbar 970.

The lock bar itself is advantageously separately carried and swung into position in its own cradle 965 just as the arm sets close, with the one lock bar 970 desirably serving all arm sets, though the lock bar function might also alternately be spread amongst a series of aligned lock bar pieces and carrying cradles. Each over-arm 962 of the arm set is shaped to have a receiving hook 964 at the end that is not hinged; each of the two over-arms 962 of each arm pair is sized to have a length such that the respective two hook-ends overlap each other, and the over-arms of each arm set are longitudinally offset just enough just enough to allow for this overlap.

The two hook ends thus overlap alongside one another with the respective openings of the hooks aligned in reciprocal directions to leave receiving channel 963 for lock bar 970, with the inner radii of the respective hooks sized to receive and interengage with the cross-sectional shape of the lock bar. Preferred lock bars will be cylindrical with circular cross-sections, but engineers will create alternatives that are within the scope of this disclosure. In action, as the over-arms close and lie freely against the pressure vessel, the assigned tolerances are such that the entry of the lockbar into the receiving channel of the combined hook-ends is an easy slip fit or looser. The tolerances are close enough however, that upon initial pressurization of the vessel, with resultant slight motion of the press halves outward, all such clearances are taken up by compliant motion of the over-arms themselves, and the hood-ends lock upon the lockbar so that it cannot be released or lifted, and at the same time the lockbar prevents any further outward motion of the over-arms which are now holding the pressure vessel securely closed.

### Deep Draw and Vacuum Active Stretch

Deep Draw and Deep Draw Preform

### Example

A stack of about 80 sheets of material are first preheated to about 250 degrees F. in an oven. A test thermocouple is advantageously used to confirm core temperature of the stack. The preheated mass of sheets is removed from the oven and laid over a preheated mold piece and sheets and mold piece are placed inside a vacuum bag. After bagging, and rigging a conventional foam tape seal around the thermocouple wire as part of the bag seal, the sheets are preformed around the mold piece as the vacuum is drawn down, and the bagged workpiece is then further heated to about 256 degrees F. and held for about 30 minutes. The part may then also optionally be pressed in a Boroclave or other HIP.

Vacuum Active Stretch

### Example

A selected number of layers of HDPE cloth are laid up and covered with a conventional perforated release layer and bagged in a conventional nylon vacuum bag material into which has been sealed a conventional two-part quick release vacuum valve over some felt material to assist the bag sides from adhering under vacuum. It is believed that the perforations in the release layer also let excess resin flow through.

Optimally the skilled artisan will adjust the bagging and vacuum drawing process to adjust for variables in surface area of bag, distance of vacuum valve to workpiece layers, and vacuum pull down rate, to thus achieve a uniform vacuum throughout the bag and material and without significant bag wrinkles

The vacuum bag and workpiece are then preheated to 270-300 degrees F. (as this is believed to be an optimum preheat stretch temp for HDPE, even though press temperature is only expected to be about 220 degrees F.).

The bagged, preheated workpiece still under vacuum is inserted into the HIP or Boroclave, with part of the vacuum bag and its valve hanging outside of the press seal, the bag still under active vacuum. The already hot press (220 F) is closed and locked and brought quickly up to 3000 psi, maintaining vacuum all through the pressing step to degas any off gassing from the material as it is pressurized under continued heat.

Press for 5 minutes at heat, then release pressure and cool slowly for about 10 minutes down to about 150 F, then rapid cool to about 80 F. Open the press and release and remove the finished article in its bag, and when cool, release vacuum and remove article from bag.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A press comprising a pressure chamber and at least one elastomeric pressure vessel, the at least one vessel filled with a substantially incompressible fluid that is in fluid communication with a pressurized source of the fluid, the pressure chamber filled with a substantially incompressible medium.

2. The press of claim 1, further comprising two closable cylindrical press halves and a plurality of cylindrical bands that slidably engageable over the ends of the press halves.

3. The press of claim 1, further comprising two closable press halves and a plurality of spaced-apart and hinged reinforcement arm pairs, each pair wrapping around the close press halves when the arm pairs are hingedly closed, each pair rapidly openable to free the press halves to open.

4. The press of claim 3, wherein each arm pair is spaced from, yet connected to, each adjacent arm pair so that all arm pairs may be opened and closed together in an action that is separate from the opening and closing of the press halves.

5. The press of claim 3, further comprising for each arm set a bottom piece that spans the underside of the pressure vessel, a hinge and two over-arms hinge dly engaged with and on opposite ends of the bottom piece; the over-arms when closed and locked, spanning one side of the pressure chamber.

6. The press of claim 5, wherein the hinge is a metal rod that serves as common hinge for all the arm sets.

7. The press of claim 3, further comprising a lock bar that is separately carried and swung into position in its own cradle.

8. The press of claim 7, wherein the lock bar serves all arm pairs.

9. An elastomeric press bladder for a hot isostatic press, the press comprising a pressure chamber, the bladder sized to fit one end of the pressure chamber.

10. The bladder of claim 9 further comprising a circumferential embedded metal ring.

11. The bladder of claim 9 further comprising at a circumference of the bladder molded lip edges having at least one cross-section complimentary to at least one shaped hollow in respective bladder/press mating parts.

12. The bladder of claim 9 further comprising slits spaced at concentric intervals from a bladder circumference on both a bladder top and a bladder bottom, the slits in the top offset from the slits in the bottom, such that as the bladder is stretched with deformational forces, the slits are widened, and as deformation forces are abated or relieved, the bladder and its slitting resume their pre-deformation configurations.

13. A method of making a composite article, the method comprising the step(s) of
stacking composite materials and preheating them;

14. The method of claim 13 further comprising the step(s) of
preforming the stacked and heated materials inside a deep draw press.

15. The method of claim 13 further comprising the step(s) of
stacking composite materials inside a vacuum bag;
drawing down an active vacuum on the bag, the bag releasably connected to a source of vacuum; and
heating the bag under continuing active vacuum.

16. The method of claim 15, wherein the vacuum bag is sealed with a plug and socket valve mechanism wherein plug and socket members are reciprocally matching, the socket member in fluid communication with the active vacuum, the plug member displaced from the socket member at least partially for fluid flow around the plug until a pressure on the plug side of the seal drives the plug into the socket.

17. The method of claim 15 further comprising the step(s) of
while still under active vacuum, placing the bag and materials in a deep draw pressure vessel;
deep drawing the materials to create an active stretch within the material fibers.

18. The method of claim 17, wherein the heated material fibers are stretched substantially beyond the conventional 30% stretch achieved in the weaving process.
